(19) United States
(12) Patent Application Publication
(10) Pub. No.: US 2024/0281078 A1
(43) Pub. Date: Aug. 22, 2024

(54) AUTOMATIC REMOTE CONTROL OF COMPUTER DEVICES IN A PHYSICAL ROOM

(71) Applicant: Merlyn Mind, Inc., New York, NY (US)

(72) Inventors: DEEPAK AKKIL, Helsinki (FI); PRASENJIT DEY, Kolkata (IN); RAVINDRANATH KOKKU, Yorktown Heights, NY (US); SHOM SURENDRAN PONOTH, Irvine, CA (US); HÉLÈNE IRENE ALONSO, New York, NY (US); SEAN O'HARA, Fort Montgomery, NY (US); SATYA V. NITTA, Cross River, NY (US)

(21) Appl. No.: 18/073,942

(22) Filed: Dec. 2, 2022

(30) Foreign Application Priority Data
Nov. 18, 2022 (IN) 202241066349

(51) Int. Cl. G06F 3/038; G06F 3/0346; G06F 3/16

(52) U.S. Cl. CPC G06F 3/038; G06F 3/0346; G06F 3/165

(57) ABSTRACT

A method of managing human-computer interaction using a remote-control unit (RCU) is disclosed. A processor within the RCU receives sensor data from a plurality of sensors within the RCU. The processor determines attributes of the RCU based on the sensor data, the attributes including at least a first user of the RCU and a position and orientation of the RCU in a physical room. The processor determines a use mode of the RCU based on the attributes. The use mode is mapped to a set of actions to be performed on a set of input/output (I/O) devices. Each action is mapped to one or more interactions with the RCU. Responsive to the processor detecting a user interaction with the RCU that is mapped to an action in the set of actions, the processor causes the action to be performed on one or more I/O devices.

### FIELD OF THE INVENTION

The present disclosure relates to remote-control of applications and media presentations. More specifically, the present disclosure relates to a smart remote-control unit that adapts to a physical environment based on attributes of the remote-control unit.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Further, it should not be assumed that any of the approaches described in this section are well-understood, routine, or conventional merely by virtue of their inclusion in this section.

Human-computer interaction through advanced user interfaces can take many forms and use many sources of information. In settings such as classrooms, teaching and learning activities take place with the assistance of various computing, input, and output devices that run computer applications and communicate with users though the input or output of the computer applications. Conventionally, besides the focus on education and student reaction, a teacher in charge of the activities in a physical room can spend considerable effort attending to the various devices. The teacher can carry and use a simple control device, such as a remote control for a projector, to perform fixed, limited control of the other devices in the physical room. The teacher could also use a complex control device, such as a cellphone, tablet, or laptop, to manipulate the other devices using advanced approaches. It would be helpful to have portable, non-intrusive, smart control units that automatically facilitate the activities in the physical room based on the states of the control units and the other devices in the physical room.

### BRIEF DESCRIPTION OF THE DRAWINGS

The example embodiment(s) of the present invention are illustrated by way of example, and not in way by limitation, in the figures of the accompanying drawings and in which like reference numerals refer to similar elements and in which:

FIG. 1 illustrates an example networked computer system in which various embodiments may be practiced.

FIG. 2 illustrates an example content presentation environment with integrated output devices paired to remote-control units in which aspects of the illustrative embodiments may be implemented.

FIG. 3 is a diagram illustrating components of a remote-control unit with physical control elements in accordance with an illustrative embodiment.

FIG. 4 is a diagram illustrating components of a remote-control unit with touchscreen control elements in accordance with an illustrative embodiment.

FIG. 5 is a diagram illustrating components of a remote-control unit having a specialized form factor in accordance with an illustrative embodiment.

FIG. 6 is a diagram illustrating example functional components of a system for a smart remote-control unit that adapts to a physical environment in accordance based on attributes of the smart remote-control unit with an illustrative embodiment.

FIG. 7A illustrates an example of determining a use mode based on the position of the remote-control unit in a physical room in accordance with an illustrative embodiment.

FIG. 7B illustrates an example of detecting a transition of use mode based on movement of the remote-control unit in a physical room in accordance with an illustrative embodiment.

FIG. 7C illustrates an example of presenting a competitive game based on interaction with the remote-control unit in a physical room in accordance with an illustrative embodiment.

FIG. 8 is a flowchart illustrating operation of a remote-control unit for pairing with integrated output devices in accordance with an illustrative embodiment.

FIG. 9 is a flowchart illustrating operation of a remote-control unit for managing user control based on user role in accordance with an illustrative embodiment.

FIG. 10 is a flowchart illustrating operation of a smart remote-control unit that adapts to a physical environment based on attributes of the remote-control unit in accordance with an illustrative embodiment.

FIG. 11 is a flowchart illustrating operation of a smart remote-control unit for a competitive game between two teams in accordance with an illustrative embodiment.

FIG. 12 is a flowchart illustrating operation of a smart remote-control unit for selecting an integrated output device for content presentation control in accordance with an illustrative embodiment.

FIG. 13 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the illustrative embodiments may be practiced without these specific details. In other instances, well-known structures and devices are shown in block diagram form in order to avoid unnecessarily obscuring the example embodiments.

Embodiments are described in sections below according to the following outline:
1. General Overview
2. Example Computing Environments
3. Example Computing Devices
4. Example Computing Components
5. Functional Descriptions
   5.1. User Management
   5.2. Device Pairing and Management
   5.3. Use Mode Determination and Input Processing
6. Example Procedures
7. Hardware Implementation
8. Extensions and Alternatives

### **

### 1. General Overview

A smart remote-control unit (RCU) is provided that adapts to a physical environment, such as a physical room, based on attributes of the RCU. In some embodiments, an RCU is operated by a user to control one or more computing and input/output (I/O) devices in a physical room. The RCU has a plurality of sensors, such as motion sensors, pressure sensors, vision sensors (cameras), and wireless communication sensors. The smart RCU is programmed to receive sensor data from the plurality of sensors and determine one or more attributes of the RCU, including a user of the RCU and a position and orientation of the RCU in a physical room. The smart RCU is programmed to determine a use mode based on the one or more attributes. Thus, the smart RCU intelligently interprets the sensor data to detect how the user intends to use the RCU to control activities in the physical room without the use mode being explicitly specified by the user.

The smart RCU can include motion sensors for determining movement and orientation of the RCU. The RCU can also use signal triangulation to determine a location within the physical room. For example, a teacher using the RCU at the front of a classroom will perform different actions than a student using the RCU at a desk in the seating area of the classroom. The smart RCU can be configured with a predetermined number of use modes that correspond to the implementation or environment. A use mode is a preconfigured mode or state of the smart RCU for performing a subset of actions associated with a user or set of users and a particular purpose or task. For instance, if the physical room is a classroom, then the smart RCU can be configured with use modes corresponding to actions that are likely to be performed by a teacher or student. An action is a set of one or more activities to be performed by the smart RCU to control the smart RCU itself, another RCU, at least one I/O device, or a combination thereof. In the example of a teacher at the front of a classroom, actions can include instructing the RCU or an I/O device to record a lesson, communicating with other RCUs to disable certain functions until instructed to re-enable the functions, instructing an I/O device to play soothing music, sending commands to an application running on a processor coupled to an I/O device, etc.

Each use mode is mapped to a set of actions to be performed on the one or more I/O devices, and each action is mapped to one or more interactions with the RCU. The smart RCU is programmed to monitor the sensor data to or opportunities to facilitate activities including human-computer interaction in the physical room based on the sensor data. The smart RCU is programmed to intelligently interpret the sensor data based on the mapping of use modes to sets of actions and based on the mapping of the actions to user interactions with the RCU. Thus, a given user interaction, such as squeezing the RCU for example, can be mapped to different actions for different use modes. In response to detecting a user interaction that is mapped to a corresponding action mapped to the current use mode, the smart RCU is programmed to cause the corresponding action to be performed on one or more I/O devices based on the sensor data.

In some embodiments, the one or more I/O devices include an integrated output device (IOD) having a processor and an output mechanism, such as a screen or a speaker. The RCU is programmed to send an identification of the use mode and an identification of the action corresponding to the user interaction with the RCU to the IOD. The IOD is programmed to determine a content presentation operation that corresponds to the identification of the use mode and the identification of the corresponding action. The IOD is programmed to then perform the content presentation operation. Thus, the IOD intelligently interprets the requested action received from the RCU based on the use mode of the RCU without the use mode or the content presentation operation being explicitly specified by the user. For example, if the user interaction includes a speech input while the use mode of the RCU corresponds to a teacher, then the smart RCU can determine that the action is to capture the speech input, convert the speech input to question text, and send the converted text to the IOD, and the content presentation operation can include displaying the text of the question spoken by the teacher to the class via a content presentation application being executed on the IOD. Similarly, if a subsequent user interaction includes a speech input while the use mode of the RCU corresponds to a student, then the smart RCU can determine that the action is to capture the speech input, convert the speech input to answer text, and send the answer text to the IOD, and the content presentation operation can include displaying the text of the answer to the question spoken by the student via the content presentation application.

In one embodiment, the smart RCU is programmed to detect that the RCU has transitioned from a first use mode to a second use mode based on the sensor data. For example, if the RCU moves from the front of the classroom to the student seating area of the classroom, then the RCU can be programmed to interpret the sensor data and determine that the use mode of the RCU transitions from a teacher use mode to a student use mode. As another example, the RCU can use motion sensors to detect that it is being thrown or rolled from one location to another, which can be an indication that the RCU is being transferred from one user, or team of users, to another. For instance, the RCU can be used in a competitive game, and competitors can toss or roll the RCU from one participant to another. Thus, the RCU can be programmed to interpret the signals and transition from one use mode to another without a user having to manually reconfigure the user interface elements of the RCU.

In some embodiments, the smart RCU is programmed to communicate with one or more I/O devices, such as IODs or even other RCUs. The RCU can be programmed to determine whether the user intends to control a particular I/O device based on the attributes of the RCU, such as a location and/or orientation of the RCU. For example, the smart RCU can be programmed to interpret motion sensors to determine when a user is moving toward a particular I/O device and pointing the RCU at the I/O device. In this case, the smart RCU can interpret the sensor data as indicating that the user intends to control the I/O device directly and transition to an I/O device control use mode. As another example, the smart RCU can be programmed to determine when a user is holding the RCU device above the user's head and pointing the RCU toward the ceiling, which can indicate that the user intends to increase the volume of all I/O devices. In this case, the sensor data that indicates the user is holding the RCU device above the user's head can indicate a “control all I/O devices” use mode, and the sensor data that indicates that the RCU is oriented such that the RCU is pointed toward the ceiling can indicate a “volume up” action. Alternatively, the smart RCU can be programmed to determine when a user is holding the RCU device downward and pointing the RCU toward the floor, which can indicate that the user intends to decrease or mute the volume of all I/O devices. In this case, the sensor data that indicates the user is holding the RCU device below the user's waist can indicate a “control all I/O devices” use mode, and the sensor data that indicates that the RCU is oriented such that the RCU is pointed toward the floor can indicate a “volume down” action. In the previous two examples, the user can enter the “control all I/O devices” use mode by either holding the RCU device over the user's head or below the user's waist depending on the action to be performed. This provides the user with different sets of actions that can be performed with the same RCU without having to reconfigure the RCU or manually assign the actions to user interface elements of the RCU.

The techniques discussed in this application have technical benefits. The smart, non-intrusive RCU that is readily integrated into activities in a physical room enables automatic and efficient interaction with computer devices, which improves human-computer interaction, including reducing response time and better utilizing device features. The RCU also allows automatic and effective coordination among computer devices, which enhances interoperability of computer devices and helps produce an improved multimedia experience. The RCU also enriches an educational environment with sophisticated, personalized communication with computer tools and computer-generated data, directly contributing to computer-assisted learning.

### 2. Example Computing Environments

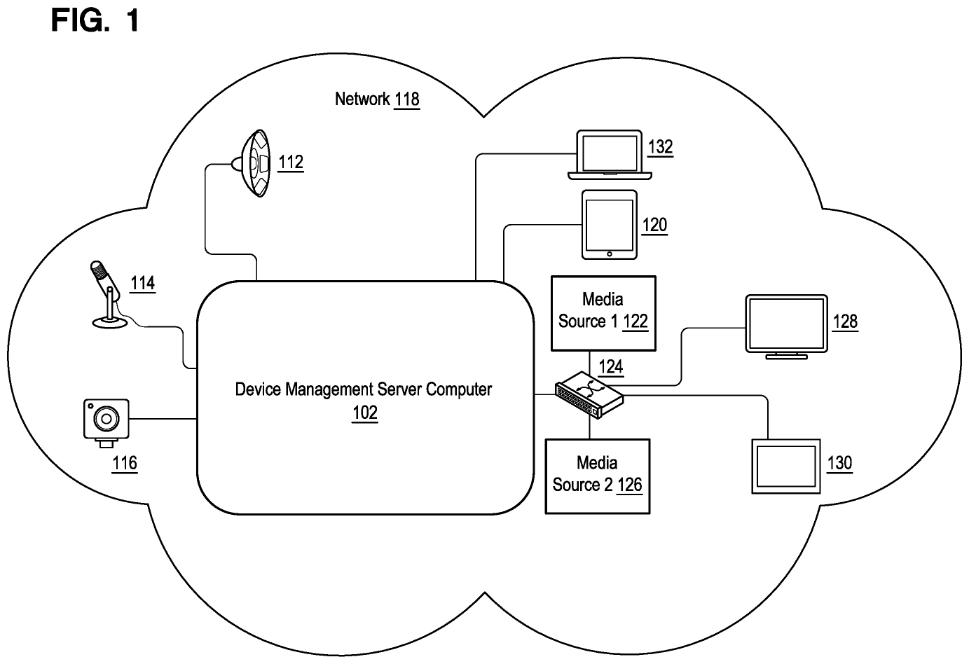

FIG. 1 illustrates an example networked computer system in which various embodiments may be practiced. FIG. 1 is shown in simplified, schematic format for purposes of illustrating a clear example and other embodiments may include more, fewer, or different elements.

In some embodiments, the networked computer system comprises a device management server computer 102 (“server”) and an I/O system, including one or more integrated devices 132 and 120 which integrate input and output capabilities, a media switch 124, one or more input devices 114, 116, 122, and 126, and one or more output devices 112, 128, and 130. The server can be communicatively coupled with each component of the I/O system via one or more networks 118 or cables, wires, or other physical components.

In some embodiments, the server 102 broadly represents one or more computers, virtual computing instances, and/or instances of a server-based application that is programmed or configured with data structures and/or database records that are arranged to host or execute functions including but not limited to managing the I/O system, collecting action data, identifying compound actions, generating user interfaces for executing the compound actions, providing the user interfaces to a client device and/or causing execution of a compound action on one or more computer devices. In certain embodiments, the server 102 can comprise a controller that provides a hardware interface for one or more components in the I/O system. For example, the server 102 can have an audio controller that communicates with I/O devices that handle audio data or a camera controller that specifically communicates with a camera. The server 102 is generally located in a physical room with the I/O system to help achieve real-time response.

In some embodiments, the I/O system can comprise any number of input devices, output devices, or media switches. An input device typically includes a sensor to receive data, such as a keyboard to receive tactile signals, a camera to receive visual signals, or a microphone to receive auditory signals. Generally, there can be a sensor to capture or measure any physical attribute of any portion of the physical room. Additional examples of a physical attribute include smell, temperature, or pressure. There can also be sensors to receive external signals, such as a navigation device to receive satellite GPS signals, a radio antenna to receive radio signals, or a set-top box to receive television signals. These sensors do not normally receive signals generated by a user but may still serve as media sources. An output device is used to produce data, such as a speaker to produce auditory signals, a monitor to produce visual signals, or a heater to produce heat. An integrated device integrates input features and output features and typically includes a camera, a microphone, a screen, and a speaker. Examples of an integrated device include a desktop computer, laptop computer, tablet computer, smartphone, or wearable device. A media switch typically comprises a plurality of ports into which media devices can be plugged. The media switch is configured to then re-direct data communicated by media sources to output channels, thus “turning on” or “activating” connections with specific output devices in accordance with instructions from the server 102. In general, one or more of the input devices can be selected to capture participant actions in addition to or instead of other activities in the physical room. The selected input devices can be dedicated to such use or can concurrently capture other activities in the physical room. For example, the microphone capturing spoken words from a participant can be connected to a speaker to broadcast the spoken words, and the microphone can also capture other sounds made in the physical room.

In this example, the media switch 124 can comprise many ports for connecting multiple media and I/O devices. The media switch 124 can support a standard interface for media transmission, such as HDMI. The media devices 122 and 126 communicating with the media switch 124 can be video sources. The server 102 can serve as an intermediary media source to the media switch 124 by converting data received from certain input devices to a format compatible with the communication interface supported by the media switch 124. The media devices 128 and 130 communicating with the media switch 124 can include a digital audio device or a video projector, which may be similar to other output devices but being specifically compatible with the communication interface supported by the media switch 124. The additional input devices 114 and 116 can be a microphone and a camera. The integrated devices 132 and 120 can be a laptop computer and a mobile phone. The server 102 and the components of the I/O system can be specifically arranged in the physical room to maximize the communication efficiency and overall performance.

The networks 118 may be implemented by any medium or mechanism that provides for the exchange of data between the various elements of FIG. 1. Examples of networks 118 include, without limitation, one or more of a cellular network, communicatively coupled with a data connection to the computing devices over a cellular antenna, a near-field communication (NFC) network, a Local Area Network (LAN), a Wide Area Network (WAN), the Internet, a terrestrial or satellite link, etc.

In some embodiments, the server 102 is programmed to receive tracked action data associated with one or more users from one or more computer devices, which could include one of the integrated devices 120 or 132. The tracking of actions and generation of tracked action data can involve receiving data regarding what is happening in the physical room by an input device and identifying and interpreting a command issued by a participant in the physical room from the data by a computing device coupled to the input device. The identification and interpretation of a command performed via physical interaction with an input device, such as a keyboard or a touchpad, for example, could be straightforward. The identification and interpretation of a command in general can be performed using existing techniques known to someone skilled in the art, such as the one described in U.S. Pat. No. 10,838,881.

In some embodiments, the server 102 is programmed to process the tracked actions associated with one or more users to identify compound actions that correspond to sequences of actions performed by a user. The server 102 is further programmed to generate instructions which, when executed by a computing device, cause an output device coupled to the computing device to present deep links each representing a compound action and usable by the user to execute the compound action in one step.

In some embodiments, the server 102 is programmed to receive invocation data indicating an invocation of a deep link from an input device or an integrated device. The server is further programmed to cause performance of the corresponding compound action, which corresponds to a sequence of actions. For example, the server 102 can send instructions for performing an action of the sequence of actions to any device required to perform the action. When the sequence of actions can all be performed by the input device or a coupled integrated device or output device, sending any invocation data to the server 102 can be optional.

### 3. Example Computing Devices

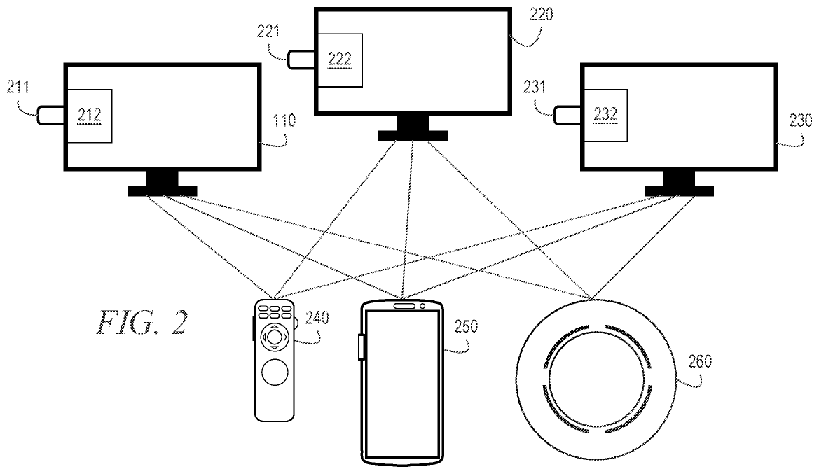

FIG. 2 illustrates an example content presentation environment 200 with IODs paired to RCUs in which aspects of the illustrative embodiments may be implemented. FIG. 2 is shown in simplified, schematic format for purposes of illustrating a clear example and other embodiments may include more, fewer, or different elements. In some embodiments, the content presentation environment 200 includes a plurality of integrated output device (IODs) 210, 220, 230, each coupled to a respective one of the dongles 211, 221, 231, and a plurality of remote-control units (RCUs) 240, 250, 260. The IODs 210, 220, 230 can be examples of media devices 128 and 130 or integrated devices 132 and 120 in FIG. 1, for example. In some embodiments, the RCUs 240, 250, 260 can communicate with the devices 120, 128, 130, 132 in FIG. 1 via the device management server computer 102. In other embodiments, the RCUs 240, 250, 260 can communicate directly with devices 120, 128, 130, 132 or via dongles 211, 221, 231, as will be described in further detail below. Each RCU could be considered as an input device, an integrated input device, or an integrated I/O device. In some embodiments, the device management server computer 102 can perform some of the workload of RCUs 240, 250, 260 or IODs 210, 220, 230. That is, some functions described below with respect to the RCUs and IODs can be provided as services that are hosted by the device management server computer 102. Examples of functions that can be provided as services include user profile management, device profile (e.g., detecting and storing capabilities of IODs) management, hosting data structures of mappings of use modes to actions and mappings of actions to user interactions, etc.

In some embodiments, each of the dongles 211, 221, 231 is coupled to its respective IOD 210, 220, 230 via a physical interface port. In one example embodiment, each of the dongles 211, 221, 231 is coupled to its respective IOD via a Universal Serial Bus (USB) interface port. In another example embodiment, each of the dongles 211, 221, 231 is coupled to its respective IOD via a High-Definition Media Interface (HDMI™) port. HDMI is a trademark of HDMI Licensing Administrator, Inc. in the United States, other countries, or both.

Each of the RCUs 240, 250, 260 has a processor and a memory for storing instructions and data structures. Each RCU is configured to execute the instructions on the processor to perform activities described below with respect to the illustrative embodiments. In an alternative embodiment, each RCU can include special-purpose hardware for performing the activities described with respect to the illustrative embodiments.

Each of the RCUs 240, 250, 260 can be paired to one or more of the IODs 210, 220, 230 via the dongles 211, 221, 231, and vice versa. The dongles 211, 221, 231 have a processor, a memory, and other resources for executing software instructions. In other embodiments, the dongles can include special-purpose hardware for performing some or all of the functions of the dongles.

In some embodiments, the RCUs 240, 250, 260 and the dongles 211, 221, 231 communicate using a radio frequency signal. The RCUs 240, 250, 260 and the dongles 211, 221, 231 are configured to generate and interpret specialized signals for communicating context information and commands. For example, context information can include a hierarchy of embedded objects or an organized set of items, including all applications installed on a given IOD. Thus, the context information can be communicated as a multi-part signal, where the first part based on the length or some other signal attributes would identify the active application, the second part the active object, and so forth. The signal format can become even more complex when there are multiple objects at the same position. Thus, in some embodiments, the RCUs and dongles or IODs communicate with a proprietary, predetermined communication protocol that specifies how context information is to be formatted in the wireless signals.

In an example embodiment, the RCUs 240, 250, 260 pair to the dongles 211, 221, 231 via a wireless network protocol, such as communication protocols used by the Bluetooth® short-range wireless technology standard. BLUETOOTH is a registered trademark of the Bluetooth Special Interest Group (SIG), Inc. in the United States, other countries, or both. The RCUs 240, 250, 260 can be paired to the IODs 210, 220, 230 in a one-to-one, one-to-many, or many-to-many arrangement. For example, RCU 240 can be paired to only IOD 210, to IOD 210 and IOD 220, or to all IODs 210, 220, 230. As another example, IOD 220 can be paired to only one RCU, such as RCU 250, to RCU 240 and RCU 250, or to all RCUs 240, 250, 260.

In an alternative embodiment, one or more of the IODS 210, 220, 230 can include wireless communication interfaces, and the RCUs 240, 250, 260 can communicate directly with the IODs without a dongle. For example, many modern devices can connect to a local area network or the Internet via wireless networking protocols and can pair with devices using the Bluetooth® short-range wireless technology standard.

In one embodiment, each of the IODs 210, 220, 230 is configured with an operating system and an application platform for executing applications for presenting content. For example, IOD 210 can be a smart TV device, also referred to as a connected TV. In some example embodiments, each of the IODs 210, 220, 230 runs an operating system, such as the Android™ platform, the tvOS™ software platform for television, or the Roku® operating system. In some example environments, the application platform can be, for example, the Roku® smart TV application platform, the webOS application platform, the tvOS® software platform for television, or the Google Play™ store. ANDROID and GOOGLE PLAY are trademarks of Google LLC in the United States and other countries. TVOS is a trademark of Apple Inc. in the United States and other countries and regions. ROKU is a trademark of Roku, Inc. in the United States and other countries. In some embodiments, one or more of IODs 210, 220, 230 are capable of communicating directly with RCUs 240, 250, 260 via wireless protocols, such as the Bluetooth® short-range wireless technology standard or the IEEE 802.11 family of standards.

In one example embodiment, each of the IODs 210, 220, 230 is also configured with a companion application 212, 222, 232 for communicating with the dongle to send context information to the RCUs 240, 250, 260 and to receive commands from the RCUs 240, 250, 260. In one embodiment, the companion application 212, 222, 232 is a device driver, which includes software that operates or controls a particular type of device that is attached to the IOD 210, 220, 230 via a USB interface port, for example. In this case, such a particular type of device could be one of the dongles 211, 221, and 231. A device driver provides a software interface to hardware devices, enabling operating systems and other computer programs to access hardware functions without needing to know precise details about the hardware being used. A device driver communicates with the device through the computer bus, such as a USB interface port, to which the hardware connects. When a calling application (e.g., an application being executed to present content, a supplemental companion application that runs in the background, or a part of the operating system) being executed on an IOD invokes a routine in the device driver, the device driver issues commands to the dongle. In response to the dongle sending data back to the device driver, the device driver can invoke routines in the original calling application.

In one embodiment, companion applications 212, 222, 232 can be background applications that stay resident in memory and collect information from the operating system and other applications running on the IODs 210, 220, 230. The background applications can be specifically designed to send information to RCUs 240, 250, 260 and receive commands from RCUs 240, 250, 260 to implement aspects of the illustrative embodiments to be described in the description below. The background applications can use application programing interfaces (APIs) of other applications executing on the IODs 210, 220, 230 to receive data from or send data to the other applications. An application programming interface (API) is a way for two or more computer programs to communicate with each other. It is a type of software interface, offering a service to other pieces of software. An API specification defines these calls, meaning that it explains how to use or implement them. In other words, the API specification defines a set of actions that can be performed by the application. Thus, the API of an application executing on an IOD can have methods or subroutines for extracting context information, such as the name of the application, the filename of a file being operated on by the application, and a position in the file that is being presented by the application. The API of an application can also have methods or subroutines for performing a set of actions. For example, the API of a presentation program can have methods or subroutines for requesting the name of the application, the name of the file being operated on by the application, and a current slide being presented. The API of an audio player application can have methods or subroutines for pausing, playing, skipping back, skipping forward, playing the next file in a playlist, etc. Background applications can make calls to implement the API of an application to request the context information or to send commands to control content presentation. In one embodiment, companion applications 212, 222, 232 can be implemented as plugins or extensions of applications executing on the IODs 210, 220, 230. For example, the companion applications 212, 222, 232 can be web browser extensions or plugins that are specific to a particular suite of office applications.

In some embodiments, one or more of the IODs 210, 220, 230 are configured with a platform for executing applications, such as a suite of office applications. In one embodiment, a web browser is installed on an IOD, and the applications are executed as services hosted by a web server. For instance, the applications can be office applications that are part of a web-based suite of office tools. Thus, the web browser is an application installed on an IOD, which can be executed to provide a platform for running and executing one or more web-based applications.

In some embodiments, dongles 211, 221, 231 are configured to install one or more applications on their respective IODs. In one embodiment, each of the dongles 211, 221, 231, upon insertion into an interface port of the IOD 210, 220, 230, installs or prompts a user to install a respective companion application on the IOD 210, 220, 230. In another embodiment, each of the dongles 211, 221, 231 can install other applications for presenting content, such as presentation software, a web browser, a video or audio program, etc. In an example embodiment, applications installed by a dongle 211, 221, 231 are instrumented with logic for collecting and reporting context information to the dongle 211, 221, 231.

IODs 210, 220, 230 can include other examples of integrated output devices that integrate a processor and memory with an output mechanism. For instance, IODs 210, 220, 230 can include a smart speaker that is capable of being controlled by an RCU 240, 250, 260. A smart speaker is a type of loudspeaker and voice command device with an integrated virtual assistant that offers interactive actions. In this example embodiment, companion applications 212, 222, 232 can be implemented as “skills” or “actions” through a virtual assistant, which provides services that provide information (e.g., weather, movie database information, medical information, etc.) or plays sound files (e.g., music, podcasts, etc.), for example. Other output mechanisms, such as overhead projectors or the like, can be integrated into IODs 210, 220, 230.

In an example embodiment, dongle 211, for example, is a digital media player device, also referred to as a streaming device or streaming box, connected to an HDMI port of the IOD 210. A digital media player device is a type of microconsole device that is typically powered by low-cost computing hardware including a processor and memory for executing applications that present media content on an output device, typically a television. In this example, the dongle 211 can run an operating system, such as the Android™ platform, the tvOS™ software platform for television, or the Roku® operating system. In some example environments, the application platform can be, for example, the Roku® smart TV application platform, the webOS application platform, the tvOS® software platform for television, or the Google Play™ store. In one example, the dongle 211 can also run the companion application 212 such that the output mechanism of the IOD 210 and the dongle 211 combine to provide appropriate services that facilitate activities in the physical room. The RCUs 240, 250, 260 can pair to the dongle 211 and control presentation of content on the output mechanism of the IOD 210 through the dongle 211.

In another example embodiment, dongle 211, for example, is a specialized computing device connected to an HDMI port of the IOD 210. For instance, dongle 211 can be implemented using a single-board computer (SBC) configured with a light-weight operating system and specialized software for implementing applications for presenting content and communicating with RCUs 240, 250, 260. A single-board computer is a complete computer built on a single circuit board, with one or more microprocessors, a memory, input/output (I/O) devices, and other features typical of a functional computer, such as wireless communication technologies. Single-board computers are commonly made as demonstration or development systems, for educational systems, or for use as embedded computer controllers. As a specific example, dongle 211 can be implemented using the Raspberry Pi™ single-board computer running the Linux™ operating system. RASPBERRYPI is a trademark of the Raspberry Pi Foundation in the United States, other countries, or both. LINUX is a trademark of the Linux foundation in the United States and other countries.

In some embodiments, RCUs 240, 250, 260 are configured to communicate directly with each other. For example, an RCU can be paired to other RCUs in the physical room or can communicate directly or through a wireless router via wireless communication. Alternatively, an RCU can communicate information to IODs 210, 220, 230, which can in turn forward the information to other RCUs in the physical room. For example, if a first RCU has control of an application running on an IOD, the IOD can inform a second RCU that the first RCU has control, and in response to the first RCU relinquishing control, the IOD can inform that second RCU that it now has control over the application.

In one embodiment, RCU 240 is an electronic device used to operate another device using physical control elements via wireless communication. In an example embodiment, the RCU 240 communicates with one or more of dongles 211, 221, 231 via radio frequency signals, the Bluetooth® short-range wireless technology, or other communication protocols or standards. In this example, the RCU 240 pairs to one or more of the IODs 210, 220, 230 via their respective dongles. The physical control elements can include buttons, scroll wheels, dials, rocker switches, etc.

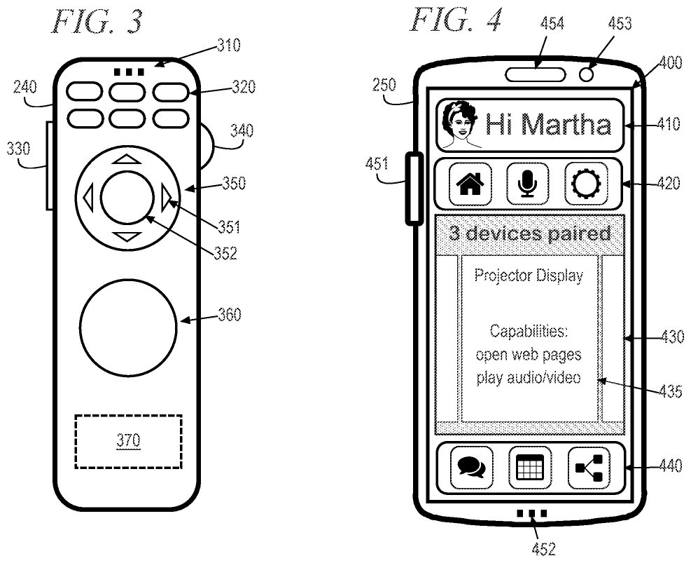

FIG. 3 is a diagram illustrating components of a remote-control unit 240 with physical control elements in accordance with an illustrative embodiment. RCU 240 includes microphone 310, physical buttons 320, rocker switch 330, scroll wheel 340, directional buttons 350, dial 360, and motion sensors 370. Physical buttons 320 can be mapped to different actions, such as executing particular applications, opening particular objects or files, activating sensors (e.g., a microphone), etc. In some embodiments, the physical buttons 320 are labeled with certain default actions, such as a microphone graphic for speech input, predetermined applications, etc.

Rocker switch 330 is configured to rock up or down on the side of RCU 240. Scroll wheel 340 is configured to rotate such that a user's thumb or finger moves in an up and down motion. Rocker switch 330 and scroll wheel 340 can be mapped to operations that logically have an up or down action, such as volume up, volume down, scroll up, scroll down, etc. In some embodiments, the rocker switch 330 and scroll wheel 340 are generally associated with up and down actions.

Directional buttons 350, sometimes referred to as a directional bad or D-pad, includes left, right, up, and down buttons 351 and a selection button 352. In some implementations directional buttons 350 can be configured to accept diagonal direction inputs as well, such as upward-left or downward-right. In some example embodiments, a user can use the directional buttons 351 to move between objects on a screen of the IOD and use the selection button 352 to select an object. In other embodiments, the directional buttons 351 can be mapped to particular actions, such as scrolling up, down, left, or right, increasing or decreasing the volume, skipping forward or back in audio or video content, next slide or previous slide, zoom in or out, moving an object on the screen, etc. In some embodiments, the directional buttons 351 are associated with directional actions, and in particular the selection button 352 is associated with a selection action.

The dial 360 can be mapped to operations that indicate rotating actions or left/right actions, such as rotating an object on the display screen of an IOD, scrolling left and right, increasing or decreasing the volume, zooming in or out, etc. In some embodiments, the dial 360 is associated with rotating actions or left and right actions.

The microphone 310 is configured to be activated for sound input or deactivated. In some embodiments, a button, such as one of physical buttons 320, can be selected to activate or deactivate the microphone 310. For example, a user can activate the microphone 310 to enter speech commands. In some embodiments, the microphone 310 is associated with actions for which there are predetermined speech commands. In another embodiment, the microphone 310 can continuously listen to monitor for a waking command to transition from a monitoring mode to a speech input mode.

The motion sensors 370 include sensors that detect movement of the RCU 240. In one example embodiment, the motion sensors 370 include accelerometers that detect movement in lateral, longitudinal, vertical, or other directions and gyroscope devices that detect rotation about lateral, longitudinal, vertical, or other axes. Thus, in this example, the motion sensors 370 include three accelerometers and three gyroscope devices to detect movement and rotation in three dimensions. In some embodiments, the RCU 240 can be calibrated with respect to a reference location such that the motion sensors 370 can track a location of the RCU 240 within a predetermined space, such as a classroom for example. In other embodiments, the motion sensors 370 can be used to detect motion gestures, such as flick right/left/up/down, wave, circle, checkmark, etc. In some embodiments, the motion sensors 370 are associated with actions for which there are predetermined motion gestures.

In one embodiment, RCU 250 is a touchscreen device, such as a smartphone device or tablet computer, for example, configured with an application for implementing functionality for controlling one or more of IODs 210, 220, 230. In one embodiment, the RCU 250 communicates with one or more of dongles 211, 221, 231 using wireless communication protocols used by the Bluetooth® short-range wireless technology standard or wireless network protocols based on the IEEE 802.11 family of standards, for example. In this example, RCU 250 pairs to one or more of IODs 210, 220, 230 via their respective dongles. In an embodiment, RCU 250 includes software user interface elements, such as touchscreen controls, voice commands, movement gestures (e.g., shaking, pointing, etc.), touchscreen gestures or other input captured by a camera, etc.

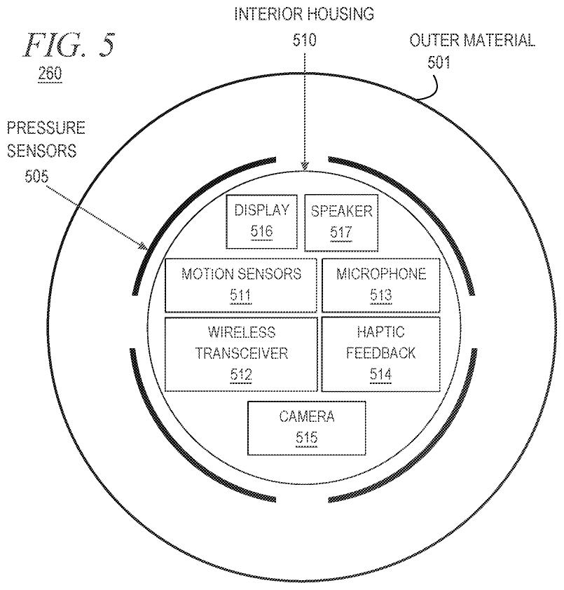

FIG. 4 is a diagram illustrating components of a remote-control unit with touchscreen user interface elements in accordance with an illustrative embodiment. In the depicted example, RCU 250 is a touchscreen device having a touchscreen interface 400, rocker switch 451, microphone 452, camera device 453, and speaker 454. Information can be presented to the user via the screen of the touchscreen interface 400 and the speaker 454. In some embodiments, the touchscreen interface 400 is used to present software controls that are configured for operation of the RCU 250. Software controls can mimic physical controls, such as buttons, dials, switches, etc. For example, software controls can include buttons, radio buttons, drop-down boxes, sliders, etc. Furthermore, the touchscreen interface 400 can also receive touchscreen gestures, such as swipe left, swipe right, swipe up, swipe down, pinch-to-zoom, two-finger rotate, etc.

Rocker switch 451 is configured to rock up or down on the side of RCU 250. Rocker switch 451 can be mapped to operations that logically have an up or down action, such as volume up, volume down, scroll up, scroll down, etc. In some embodiments, the rocker switch 451 is generally associated with up and down actions. The microphone 452 is configured to be activated for sound input or deactivated. In some embodiments, a button, such as a software button, can be selected to activate or deactivate the microphone 452. For example, a user can activate the microphone 452 to enter speech commands. In some embodiments, the microphone 452 is associated with actions for which there are predetermined speech commands.

The camera 453 is configured to receive video input. In one embodiment, the camera 453 is used to receive video of the user's face for facial recognition, lip reading, etc. In another example embodiment, the camera 453 can be used to recognize movement of the RCU 250. For example, one or more machine learning models can be trained to recognize different motion gestures, such as flick left, flick right, wave, etc.

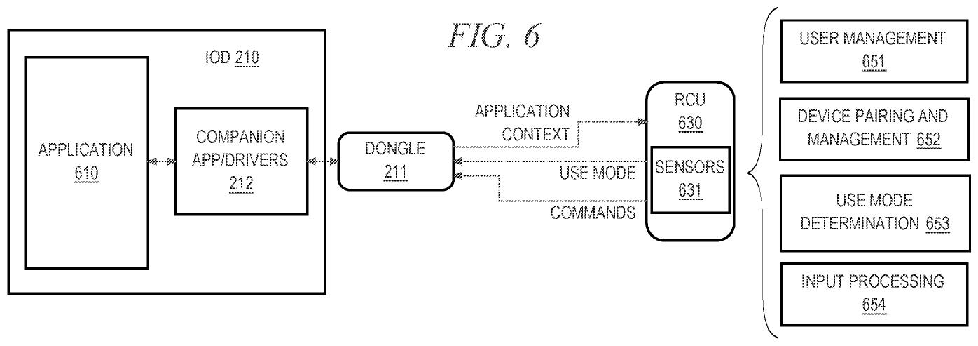

In an embodiment, RCU 260 is a device having a specialized form factor for interaction in a particular environment. FIG. 5 is a diagram illustrating components of a remote-control unit 260 having a specialized form factor in accordance with an illustrative embodiment. In one example embodiment, RCU 260 has a substantially spherical shape with an interior housing 510, which contains a processor, a memory, communication devices, input sensors, and output devices, and a soft outer material 501, such as a foam material, surrounding the interior housing. In some embodiments, interior housing 510 contains motion sensors 511, wireless transceiver 512, microphone 513, haptic feedback devices 514, camera 515, display 516, and speaker 517. The interior housing 510 can contain more or fewer components depending on the implementation, and some components shown inside the interior housing can be positioned outside the interior housing, and vice versa. In this example, RCU 260 can function as a ball that can be thrown, bounced, rolled, or squeezed. In some example embodiments, RCU 260 is used in a classroom environment such that the RCU 260 can be thrown or rolled from a teacher to a student or between students. The various sensors, such as the motion sensors 511, microphone 513, or camera 515, serve as input devices and collect user input. The user interface elements in this case could correspond to the RCU 260 as a whole or specified portions of the RCU. For example, a user action can be rotating the RCU 260 180 degrees, and another user action can be squeezing the bottom of the RCU 260 with a left hand.

In one embodiment, the components of the RCU 260, particularly the components within the interior housing 510, are welded or otherwise fastened and protected using known techniques to stay intact during motion. In the example of a classroom, it is advantageous to provide an RCU 260 that can withstand exaggerated user interactions, especially in embodiments where the RCU 260 is used to play games involving throwing or bouncing.

The motion sensors 511 include sensors that detect movement of the RCU 260. In one example embodiment, the motion sensors 511 include accelerometers that detect movement in lateral, longitudinal, vertical, or other directions and gyroscope devices that detect rotation about lateral, longitudinal, vertical, or other axes. Thus, in an example, the motion sensors 511 include three accelerometers and three gyroscope devices to detect movement and rotation in three orthogonal dimensions. In some embodiments, the RCU 260 can be calibrated with respect to a reference location such that the motion sensors 511 can track a location of the RCU 260 within the physical room, such as a classroom. In other embodiments, the motion sensors 511 can be used to detect a series of changing positions of the RCU 260 over time, which can be associated with motion gestures. For example, the series of changing positions can include a higher position for two seconds followed by a lower position for three seconds. Examples of motion gestures include flick right/left/up/down, wave, circle, checkmark, etc. In some embodiments, the motion sensors 511 are associated with actions for which there are predetermined motion gestures. The RCU 260 can also use motion sensors 511 to detect when the RCU 260 is being bounced, thrown, or rolled. In addition, the RCU 260 can use motion sensors 511 to track movement of the RCU 260 and, thus, to detect a location of the RCU 260.

In one embodiment, the RCU 260 includes pressure sensors 505, which detect pressure caused by squeezing or bouncing the RCU 260 in terms of amount, position, direction, duration, or other attributes. For example, a student can squeeze the RCU 260 for two seconds to activate microphone 513 and enable speech input. As another example, the teacher can hold the RCU 260 over the head and squeeze the RCU 260 to mute the volume on IODs 210, 220, 230 via wireless transceiver 512 to get the attention of students. Furthermore, the RCU 260 can use pressure sensors 505 to detect when and how the RCU is bounced, which can be interpreted as a user input element.

In one example embodiment, the RCU 260 has a transparent portion of the surface, which can be substantially flat or curved, such that a user can see the display 516 inside the RCU 260 and such that the camera 515 within the internal housing can capture video input. The RCU 260 can be designed to have a center of gravity that is farther from the flat surface than the center of the volume of the RCU, to help ensure that the curved end is on the bottom for holding while the flat side is on the top for viewing while suffering less friction. In an embodiment, video input received by camera 515 can be used to augment motion sensors 511 for location determination and for motion gesture detection. In addition, the camera 515 can receive video input of a user's face for facial recognition for identifying the user of the device.

The RCU 260 can present information to users via the display 516 or by haptic feedback devices 514. Haptic feedback, sometimes referred to as “force feedback,” includes technology that provides feedback to the user by touch. Examples of haptic feedback devices 514 include vibration devices and rumble devices. Audio feedback can also be provided to the user via speaker 517. In one embodiment, the RCU 260 can use speaker 517 to amplify speech input provided to microphone 513.

The RCU 260 uses wireless transceiver 512 to receive information from and to send commands or requests to IODs 210, 220, 230 via their respective dongles. In some embodiments, the RCU 260 uses wireless transceiver 512 for detecting a location of the RCU 260 by triangulating signals received from multiple devices in the environment. For example, the RCU 260 can measure a strength of signals received from dongles 211, 221, 231 and/or from other devices that transmit wireless signals.

In other embodiments, the specialized form factor of an RCU can take different shapes or compositions. For example, an RCU can take the form of a cube, pyramid, rod, etc. As another example, an RCU can take the form of a toy, such as a stuffed bear, action figure, scale model car or airplane, etc. Other form factors will become apparent in different implementations and different environments. For instance, in a teaching environment in which life-saving techniques are being taught, an RCU can take a humanoid form.

The RCUs 240, 250, 260 are configured or programmed to send commands to the IODs 210, 220, 230 in response to user interaction with user interface elements of the RCUs 240, 250, 260. In one embodiment, the commands are encoded as standard keyboard scan codes, such as character codes, number codes, cursor movement codes, space and enter codes, etc. Alternatively, the RCUs 240, 250, 260 are configured or programmed to send more complex commands, such as coordinates on a touchscreen input area, custom requests or commands, for example.

### 4. Example Computing Components

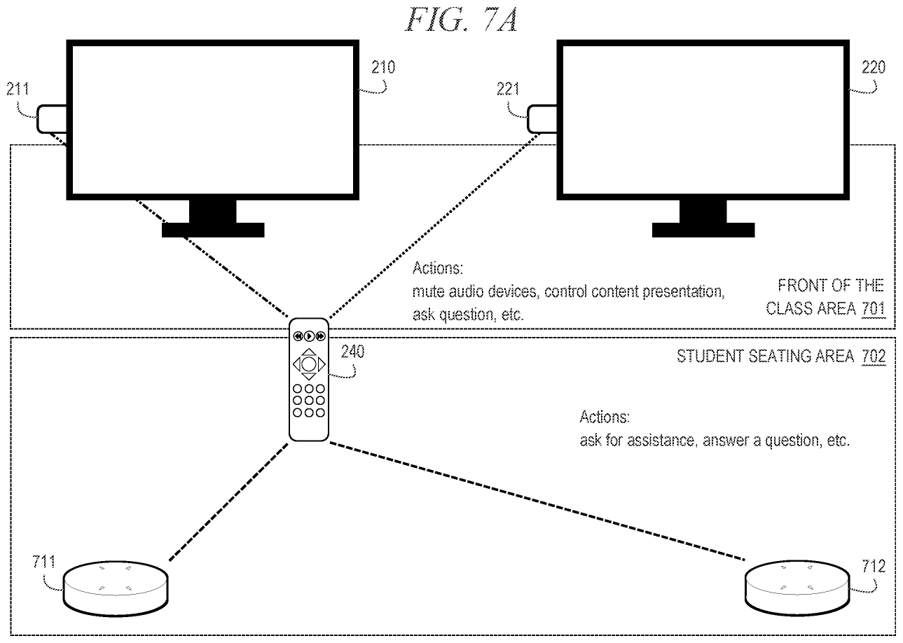

FIG. 6 is a diagram illustrating example functional components of a system for a smart remote-control unit (RCU) that adapts to a physical environment based on attributes of the RCU in accordance with an illustrative embodiment. FIG. 6 is an expanded diagram of components within content presentation environment 200 shown in FIG. 2. In an embodiment, application 610 and companion application 212 execute on IOD 210. The IOD 210 is coupled to dongle 211 as described above. The dongle 211 is paired with one or more RCUs, such as RCU 630, which can be any one of RCUs 240, 250, 260 in FIG. 2, for example. RCU 630 includes user management service 651, device pairing and management service 652, use mode determination service 653, and input processing service 654.

In some embodiments, the application 610 is one of a plurality of applications installed on the IOD 210 to present content and perform other tasks in the physical space. In one example embodiment, the application 610 executes within a platform, such as a web-based suite of office tools. Thus, the application 610 can be an application that is installed directly on the IOD 210, an application that executes within an application platform, or an application that executes as a service that is hosted by a server.

The user management service 651 enables a user to log in using a user profile and customizes the user interface elements of the RCU 630 according to the user profile. In some embodiments, the user management service 651 authenticates the user by prompting the user to enter a password or personal identification number (PIN). In other embodiments, the user management service 651 can authenticate the user by performing facial recognition or voice recognition or by using biometric sensors, such as a fingerprint sensor, for example. User profiles can be associated with certain authorized actions. For example, a teacher or administrator can perform actions that students are not authorized to perform.

Device pairing and management service 652 provides functions that allow the user to pair the RCU 630 to different IODs, to unpair the RCU from IODs, and to switch control between the IODs that are paired to RCU 630. Pairing the RCU 630 to an IOD 210 establishes a connection between the RCU and the IOD such that information is passed for customizing the RCU 630 and for controlling the IOD. For example, the IOD 210 can send context information to the RCU 630 that specifies the applications installed on the IOD 210 and capabilities of the applications. The user can then select which IOD to control based on these capabilities.

The use mode determination service 653 receives sensor data from a plurality of sensors 631. The use mode determination service 653 determines one or more attributes of the RCU 630 based on the sensor data. In some embodiments, the attributes include a camera, a microphone, motion sensors, pressure sensors, wireless transceivers, etc. For example, the RCU 630 can be programmed to use a camera, microphone, or biometric sensors to identify a user of the device. As another example, the RCU 630 can be programmed to use motion sensors (e.g., accelerometers and angular rate sensors), camera input, and/or triangulation of signals received by the wireless transceivers to determine a position and orientation of the RCU 630 within the physical room. As a further example, the RCU 630 can be programmed to interpret sensor data from motion sensors to determine movement of the RCU 630, such as whether the RCU 630 is being thrown, rolled, bounced, etc. A another example, the RCU 630 can be programmed to determine whether the RCU 630 is in a position that is close to the user's mouth, over the user's head, below a user's waist, etc.

The use mode determination service 653 determines a use mode of the RCU 630 based on the one or more attributes of the RCU 630. In some embodiments, the RCU 630 is configured with a predetermined set of use modes that are anticipated to be encountered in the content presentation environment or the physical room. For example, in a classroom environment, there may be a plurality of use modes for a teacher and a plurality of use modes for the students. For instance, there may be a use mode for the teacher when conducting a lesson at the front of the classroom, a use mode for the teacher when assisting students with assignments, a use mode for the teacher when supervising a test or quiz, etc. Similarly, there may be a use mode for a student when presenting a project, a use mode for a student when requesting control of an I/O device, a use mode for a student when competing in a game, a use mode for passing control to another student, etc. The predetermined use modes can vary depending on the specific implementation, the content presentation environment, or the physical room.

Each use mode is mapped to a set of actions to be performed on a set of I/O devices. For example, a use mode for a teacher when supervising a test or quiz can be mapped to actions for controlling ambient music being played on one or more audio devices to help the students to remain focused and to actions for controlling presentation of a question and a timer on a video device. As another example, a use mode for a student when competing in a game can be mapped to actions for receiving speech input, signaling when a task has been completed, etc.

Each action is mapped to one or more interactions with the RCU 630. For example, an action of muting audio devices can be mapped to holding the RCU 630 overhead and moving the RCU 630 in a counterclockwise motion, and an action of signaling when a task has been completed can be mapped to bouncing the RCU 630. The input processing service 654 monitors the sensors 631 for user interaction with the RCU 630 that matches one of the actions mapped to the current use mode. Responsive to detecting a user interaction that is mapped to an action in the set of actions corresponding to the current use mode, the RCU 630 causes the corresponding action to be performed on one or more I/O devices. Thus, a particular interaction with the RCU 630 can result in different actions being performed depending on the use mode of the RCU 630.

The input processing service 654 receives sensor data and determines particular user interactions with the RCU. The input processing service 654 interprets the sensor data and user interactions and sends RCU commands or requests to dongle 211. In one embodiment, the commands are encoded as standard keyboard scan codes, such as character codes, number codes, cursor movement codes, space and enter codes, etc. In another embodiment, the commands are conventional remote codes for controlling media devices, such as cable boxes, digital video disk (DVD) players, etc. Alternatively, the input processing service 654 generates more complex commands, such as custom requests or commands. For example, complex commands can be any commands that can be received and understood by the dongle and applications running on the IOD. For instance, there may be commands that are derived from the application's API specification.

In an embodiment, an RCU can be configured to send a command, automatically or in response to a user input, to start an application or switch to an application that is appropriate to perform a given action. For example, if an action involves playing a sound file, then the RCU can be configured to send a command to an IOD to execute an audio player application or switch to an audio player application that is running in the background. In another embodiment, the RCU can be configured to switch to another paired IOD. Thus, in the example of an action that involves playing a sound file, the RCU can be configured to switch to an IOD with audio only capabilities.

### 5. Functional Descriptions

### 5.1. User Customization

Returning to FIG. 4, an example user interface of remote-control unit 250 for managing multiple device pairings is shown. In the depicted example, RCU is a touchscreen device, such as RCU 250 in FIG. 2. The user interface of RCU 250 includes a user profile portion 410, a fixed interface portion 420, a paired device management portion 430, and a user favorites portion 440. The user profile portion 410 presents user interface elements that allow a user to log into a user account. In some embodiments, other user interface portions can be customized based on which functions or operations are authorized for different users. For example, a teacher can be authorized to perform different functions than a student. In the example shown in FIG. 4, a user “Martha” is logged in. The user customization engine customizes the user interface panels of the RCU based on the user profile such that the user interface presents user interface elements for functions that are authorized for the user.

The fixed interface portion 420 includes fixed user interface elements for functions that are consistent throughout operation within the content presentation environment 200. In the example depicted in FIG. 4, the fixed interface portion 420 includes a home button, a speech input button, and a configuration options button. As described above, user interface elements included in fixed interface portion can be selected based on the user that logged in via user profile portion 410. In one embodiment, RCU 250 is assigned a role based on the user that is logged into the RCU 250. Thus, different RCUs can be assigned different roles for an IOD based on the users logged into the RCUs. For example, an IOD can be paired with multiple RCUs including a teacher RCU and one or more student RCUs. The user interface elements presented in the user interface portions 420, 430, 440 can be customized based on the role of the RCU 250.

The user favorite interface portion 440 includes user interface elements selected by a user. In one embodiment, user favorite interface portion 440 allows the user to select favorite user interface elements, such as a chat application icon, a calendar application icon, and a share icon. The RCU 250 can be programmed to allow the user to specify which user interface elements are presented in user favorite interface portion 440. In another embodiment, the RCU 250 is programmed to identify which user interface elements are selected most recently, most often, or more frequently by the user. The RCU 250 can then present the identified user interface elements in the user favorite interface portion 440.

### 5.2. Device Pairing

Returning to FIG. 2, the RCUs 240, 250, 260 can be paired to the IODs 210, 220, 230 in a one-to-one, one-to-many, or many-to-many arrangement. For example, RCU 240 can be paired to only IOD 210, to IOD 210 and IOD 220, or to all IODs 210, 220, 230. As another example, IOD 220 can be paired to only one RCU, such as RCU 250, to RCU 240 and RCU 250, or to all RCUs 240, 250, 260. Thus, in FIG. 6, RCU 630 can be paired with other dongles in addition to dongle 211.

In one embodiment, fixed interface portion 420 includes user interface elements for selecting which user interface portion is displayed in portion 430. Thus, in the depicted example, the fixed interface portion 420 can include a “paired device management” icon. For example, a “paired device management” icon can be presented in place of the speech input icon. In response to the user selecting the “paired device management” icon, paired device management interface portion 430 is displayed. In response to the user selecting the “paired device management” icon, the “paired device management” icon can be replaced with the speech input icon, for example.

The device pairing service 652 presents an IOD user interface card 435 for each IOD paired to the RCU 250 in the paired device management interface portion 430. Each IOD user interface card presents an identifier of a respective IOD and a list of capabilities of the IOD. The user can switch the IOD being controlled by the RCU 250 by switching between the IOD user interface cards 435. In one example embodiment, the user can switch between the IOD user interface cards by swiping left and right. In an alternative embodiment, the IOD user interface cards 435 can be presented vertically, and the user can swipe up and down. Other techniques for switching between IOD user interface cards 435 can be used in other embodiments.

In one embodiment, the device pairing service 652 allows the user to rearrange IOD user interface cards 435 in device management interface portion 430 so that the IOD user interface cards 435 are physically congruent with the IODs. That is, a user can rearrange the IOD user interface cards 435 such that a IOD user interface card on the left corresponds to an IOD on the left side of the content presentation environment, an IOD user interface card in the center corresponds to an IOD in the center of the content presentation environment, and an IOD user interface card on the right corresponds to an IOD on the right side of the content presentation environment. In one embodiment, the user can enter a rearrangement mode by long-pressing within the device management interface portion 430.

In some embodiments, the device pairing service 652 determines actions to assign to user interface elements based on capabilities of the selected IOD card 435. For example, the selected IOD card 435 can indicate that the IOD has a capability of opening web pages. In one embodiment, the user interface assigns actions of running a web browser application and opening a web page associated with a chat service to a particular user interface element. In response to the user selecting a particular user interface element, the RCU 250 is configured to send the action to the dongle 211.

### 5.3. Use Mode Determination

In some embodiments, an RCU is programmed to receive sensor data including sensor signals produced by various sensors continuously and in real time. The RCU is programmed to then determine how to interpret the sensor data. As further discussed below, the interpretation can be applied across sensor signals or over multiple time units. The RCU can be configured to track all the sensor signals received so far and match them to predetermined combinations of sensor signals until a match is found, before applying an interpretation. The predetermined combinations of sensor signals can be ranked for conflict resolution when multiple matches are found. For example, over a period of five seconds, all the received sensor signals can include a match to a series of positions closer to an IOD. Such a match can be interpreted to indicate a use mode, and these received sensor signals are tracked no longer and excluded from further matching and interpretation. During the next two seconds, all the received sensor signals may include a match to an utterance of a speech command. Such a match can be interpreted to specify an action to be performed by an IOD, and these received sensor signals are similarly excluded from further matching and interpretation. In other embodiments, the RCU could receive specific indicators of a change in interpretation. For example, after concluding a match to a user interaction that specifies an action to be performed by an IOD, the RCU could be configured to ignore newly received sensor signals until an update on the current state of the IOD is received from a dongle.

In some embodiments, the RCU is configured with a machine learning (ML) model that is trained to classify sensor signals and other inputs to identify a use mode. In one embodiment, the machine learning model is a classification ML model that is trained using a training data set by recording sensor data during everyday use in a particular environment and labeling the recorded sensor data with known use modes. For example, collecting training data can include gathering a first set of sensor data while a teacher is at the front of a classroom presenting a lesson, labeling the first set of sensor data with a first use mode, gathering a second set of sensor data while the teacher is in the student seating area of the classroom assisting students, labeling the second set of sensor data with a second uses mode, gathering a third set of sensor data while a student is in the student seating area of the classroom asking a question, labeling the third set of sensor data with a third use mode, and so on. The training data can be labeled with the use modes, and the ML model can then be trained based on the labeled training data. The classification ML model can be based on a known classification algorithm, such as logistic regression, Naïve Bayes, k-nearest neighbor, decision tree, or random forest, for example.

In one example embodiment, a classification ML model receives a set of inputs that include sensor data over a period of time (e.g., three seconds, five seconds, an hour, etc.) and other inputs, such as a current use mode, an identification of a user, a role of the user, etc. In one embodiment, the user can be identified based on the sensor data. In this example, the ML model provides a set of outputs that include a confidence score for each classification, where each classification corresponds to a use mode. A higher confidence score indicates a higher probability that the RCU is being used in the corresponding use mode, and a lower confidence score indicates a lower probability that the RCU is being used in the corresponding use mode. Thus, the RCU can be configured to rank the classifications by confidence score and determine the current use mode based on the highest confidence score. In one embodiment, the RCU can be configured to transition from a current use mode to a subsequent use mode only if a confidence score associated with the subsequent use mode is greater than a predetermined threshold. In another embodiment, the classification ML model can be configured to give a higher weight to the current use mode such that the RCU will tend to stay in the current use mode unless the sensor data clearly indicate a transition to a subsequent use mode. In one embodiment, the smart RCU can be configured to transition to a new use mode in response to detecting the new use mode. Alternatively, the smart RCU can be configured to prompt the user to transition to the new use mode via a screen or voice prompt.

In another embodiment, the machine learning model is a classification model that is trained to identify a use mode transition using a training data set by recording sensor data during transitions from one use mode to another use mode. For example, collecting training data can include gathering a first set of sensor data when a teacher transitions from a lesson use mode to a student assistance use mode, gathering a second set of sensor data when a teacher transitions from a lesson use mode to an I/O device control use mode, a third set of sensor data when a student transitions from a question answering use mode to a project presentation use mode, etc. The training data can be labeled with the use mode transitions, and the ML model can then be trained based on the labeled training data. The prediction ML model can be based on known predictive algorithms, such as decision tree, regression, neural networks, or time series algorithms, for example.

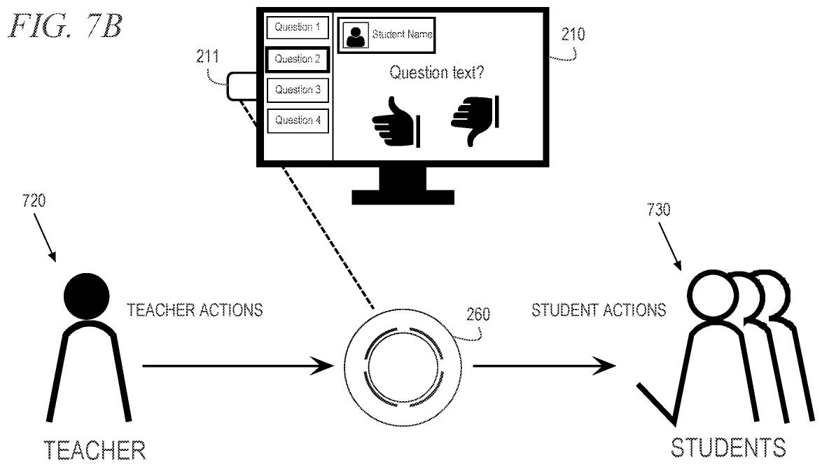

FIG. 7A illustrates an example of determining a use mode based on the position of the remote-control unit in a physical room in accordance with an illustrative embodiment. In the depicted example, the RCU 240 communicates with dongle 211 or dongle 221 to control content presented on or otherwise control operation of IOD 210 or IOD 220, respectively. The RCU 240 communicates with dongle 211 or dongle 221 via wireless communication protocols, such as radio frequency or the Bluetooth® short-range wireless technology standard. The RCU 240 also communicates with one or more of pucks 711, 712 via wireless communication protocols. Pucks 711, 712 can be wireless access points or beacons for triangulation of wireless signals. In accordance with the illustrative embodiments, the dongles 211, 221 and the pucks 711, 712 have fixed positions and transmit signals with substantially consistent signal strength. The RCU 240 is programmed to determine a signal strength received from three or more of the dongles 211, 221 and pucks 711, 712. With three or more signal strength values and known, fixed positions of the dongles 211, 221 and pucks 711, 712, the RCU 240 can be programmed to determine a position of the RCU 240 within the physical room.

In some embodiments, the RCU 240 can also receive sensor signals from motion sensors to augment the position determination of the RCU 240. In one embodiment, the motion sensors can include accelerometers that detect movement in lateral, longitudinal, and vertical directions and gyroscope devices (angular rate sensors) that detect rotation about lateral, longitudinal, and vertical axes. In another embodiment, the motion sensors can include a camera or a microphone, and the RCU 240 can be programmed to determine motion of the RCU 240 based on the data captured by the camera or the microphone. Thus, the RCU 240 can be programmed to augment the position determination and more accurately calculate the position of the RCU 240 in the physical room especially as the RCU 240 moves, to calculate a vertical position of the RCU 240, or to determine an orientation of the RCU 240 (e.g., pointing up, pointing down, pointing toward the front of the physical room, etc.).

In the example shown in FIG. 7A, the physical room is a classroom that includes a front of the class area 701 and a student seating area 702. The RCU 240 can be programmed to determine whether the RCU 240 is positioned in the front of the class area 701 or in the student seating area 702. In one embodiment, a use mode is determined by the current position of the RCU in the physical room based on sensor signals. For example, a teacher use mode is associated with the front of the class area 701, and a student use mode is associated with the student seating area 702. The use mode determines the set of actions that can be performed on an I/O device by the user of the RCU. One set of actions is mapped to the teacher use mode, including muting audio devices, controlling content presentation, asking questions, etc. A second set of actions is mapped to the student use mode, including asking for assistance, answering a question, etc. Therefore, when the RCU 240 is positioned in the front of the class area 701, the RCU 240 is in the teacher mode, and the user can perform the first set of actions. When the RCU 240 is positioned in the student seating area 702, the RCU 240 is in the student use mode, and the user can perform the second set of actions.

Furthermore, the RCU 240 is programmed to determine when the RCU 240 changes position from the front of the class area 701 to the student seating area 702 and, thus, transition from the teacher use mode to the student use mode. Conversely, the RCU 240 is programmed to determine when the RCU 240 changes position from the student seating area 702 to the front of the class area 701 and, thus, transitions from the student use mode to the teacher use mode. The RCU 240 is programmed to detect when the RCU 240 transitions use modes based on the sensor signals and to automatically change the mappings of user interactions to actions with the RCU 240. In one embodiment, the mappings are stored as data structures in the RCU, one mapping data structure for each use mode, and the RCU uses a mapping data structure corresponding to a current use mode for interpreting user interactions. Thus, the RCU determines a use mode based on sensor data, and each use mode identifies a mapping data structure that maps user interactions to actions. The user interactions are also determined based on sensor data.

In one embodiment, the RCU 240 is programmed to determine to which IOD 210, 220 the RCU 240 is closest. The RCU 240 can then determine whether the use mode is for controlling IOD 210 or IOD 220 based on the position and orientation of the RCU 240 in the physical room. For example, when the RCU 240 is closer to the IOD 210 than any other IOD or the RCU 240 is pointed toward the IOD 210 instead of another IOD, then the RCU 240 can be programmed to determine that it is in a use mode associated with controlling the IOD 210. As another example, the user may be inclined to move toward the IOD 210, 220 when attempting to control the IOD 210, 220. Thus, if the RCU 240 is in the front of the class area 701 or moving toward the IOD 220 (e.g., via a throwing or thrusting motion), then the RCU 240 can be programmed to determine that it is in a use mode associated with controlling the IOD 220.

In one example embodiment, an RCU can be in multiple use modes at a given time. For example, while a teacher is logged into a user account and using the RCU at the front of the classroom, the RCU can be in a use mode associated with a teacher presenting a lesson to the class, and in addition the RCU can be in a use mode associated with a teacher controlling all I/O devices in the classroom when the teacher holds the RCU over the teacher's head. In an embodiment, some use modes may be mutually exclusive. For instance, an RCU may be configured such that the RCU cannot be in a teacher use mode and a student use mode at the same time.

In some embodiments, a use mode can be determined by any combination of sensor signals or derived data obtained by the RCU. Similarly, the set of actions that can be or are to be performed on the I/O devices could be directly determined by any combination of sensor signals or derived data. For example, known image or sound recognition techniques could be used to determine the presence of a person or an object or the occurrence of an event as derived data. Changes in sensor signals of the RCU can be caused by user interactions or environmental factors, which can indicate user intent or activity status of the physical room. In the examples discussed above, the combination of sensor signals includes the position within the physical room or the physical relationship with an IOD. The combination of sensor signals could also include the physical relationship with a person or any location within the physical room, such as proximity to any group of people or the volume of the current user of the RCU, or current condition of the physical room, such as the noise level or the temperature in the physical room. The combination of sensor signals could be detected contemporaneously or in some other temporal relationship. For example, the combination of signals may include a certain pressure and a certain orientation at the same time, or it may include a set of consecutive positions towards a specific location within the physical room.

Accordingly, the set of actions can be predetermined to capture user intent or improve the activity status of the physical room. Such determination (which can be associated with various mappings discussed above) can be performed via machine learning or based on specific rules. The RCU could be programmed to capture and analyze many series of user interactions with the RCU, and train a computer model to predict later user interactions of a series (which could be mapped to user interface elements of the RCU, for example) from recognizing the earlier user interactions of the series (which could then be used to identify a use mode, for example). The predicted actions can be performed automatically or presented to a user for approval.

In some embodiments, the RCU is configured with an ML model that is trained to classify sensor signals and other inputs to identify a user interaction with the RCU or other factors that would trigger one or more actions to be performed. In one embodiment, the machine learning model is a classification ML model that is trained using a training data set by recording sensor data during everyday use in a particular environment and labeling the recorded sensor data with known user interactions (e.g., squeezing the RCU, moving the RCU in a deliberate manner or gesture, speech input, throwing or rolling the RCU, etc.). Other factors can include a fire alarm being sounded, volume of ambient noise and background voices increasing, a camera detecting movement of people, etc. In some examples, the other factors can include a lack of signals. For instance, the sensor data may indicate that the physical room has been vacated, in response to which the smart RCU can be configured to turn off all I/O devices in the physical room. In an example embodiment, collecting training data can include gathering a first set of sensor data while a user is bouncing the RCU, labeling the first set of sensor data with a first user interaction label, gathering a second set of sensor data while the user is squeezing the RCU, labeling the second set of sensor data with a second user interface label, gathering a third set of sensor data while a user is moving the RCU in a circle, labeling the third set of sensor data with a third user interaction label, and so on. The training data can be labeled with the user interaction labels, and the ML model can then be trained based on the labeled training data. The classification ML model can be based on a known classification algorithm, such as logistic regression, Naïve Bayes, k-nearest neighbor, decision tree, or random forest, for example.

In one example embodiment, a classification ML model receives a set of inputs that include sensor data over a period of time (e.g., one second, three seconds, five seconds, etc.) and other inputs, such as a current use mode, an identification of a user, a role of the user, etc. In one embodiment, the user can be identified based on the sensor data. In this example, the ML model provides a set of outputs that include a confidence score for each classification, where each classification corresponds to a user interaction. A higher confidence score indicates a higher probability that the user is performing the user interaction with the RCU, and a lower confidence score indicates a lower probability that the user is performing the corresponding user interaction with the RCU. Thus, the RCU can be configured to rank the classifications by confidence score and detect a user interaction based on the highest confidence score. Thus, the RCU can include a first ML model for detecting a use mode of the RCU and a second ML model for detecting user interactions with the RCU.

The RCU could also be configured to enforce a given list of rules. For example, the rules may specify the desired temperature, noise level, lighting, density, or power usage of the physical room (or a portion thereof). In moving around the physical room with the user of the RCU, the RCU can be configured to automatically control various I/O devices, such as starting off, shutting down, suspending, resuming, or increasing or decreasing intensity, to achieve an appropriate education environment. For example, in detecting that the teacher is speaking in a flat tone and very few students are sitting in the front row near the teacher holding the RCU, the RCU could send an instruction to a speaker to request students to move up; in detecting that the user of the RCU screams and quickly approaches a person or an object in the physical room, the RCU would send an instruction to a lighting equipment to dim the room but keep one light source to follow the user's movement.

FIG. 7B illustrates an example of detecting a transition of use mode based on movement of the remote-control unit in a physical room in accordance with an illustrative embodiment. In the depicted example, the RCU 260 has a ball form factor and communicates with dongle 211 to control a computer application running on IOD 210. The RCU 260 communicates with dongle 211 via wireless communication protocols, such as radio frequency or the Bluetooth® short-range wireless technology standard. In this example, the content being presented on IOD 210 is a question answering game being controlled by the teacher 720.

In one embodiment, the RCU 260 is programmed to determine that when the teacher is holding the RCU 260, the RCU 260 is in a teacher use mode and capable of performing a first set of teacher actions. The determination can be made based on the detected position known to be where the teacher is located, detected fingerprint known to be from the teacher's hand, or detected scent known to be the teacher's fragrance, detected sound known to be the teacher's voice, for example. For example, teacher actions can include selecting a question to be answered by a student, such as a true-or-false question, presented on the left panel of the screen of IOD 210. The RCU 260 (or an RCU in any form factor) can also be configured with predetermine mappings between user interactions with the RCU 260 and commands to be performed by the IOD 210 and configured to select one of these mappings based on the determined use mode or other factors. The detection of user interactions would be based on a further combination of sensor signals. For example, in one such mapping, all the actions can be communicated as voice commands to be captured by the microphone of the RCU 260. In another such mapping, the question selection action can be mapped to a particular interaction with the RCU 260, such as moving the RCU 260 up-and-down in the air and squeezing the RCU 260 to select the question. The teacher can then throw or roll the RCU 260 to one or more students 730.

In response to the teacher throwing or rolling the RCU 260, the RCU 260 can be programmed to similarly determine that when a student is now holding the RCU, the RCU 260 is to transition from a teacher use mode to a student use mode, and the student use mode can be mapped to a second set of student actions. For example, student actions can include selecting an answer to the question presented on a right panel of the screen of IOD 210. The answer selection action can be mapped to a particular interaction with the RCU 260, such as moving the RCU 260 left-and-right in the air and squeezing the RCU 260 to select the answer. The one or more students 730 can then throw or roll the RCU 260 back to the teacher 720 to select the next question.

The RCU 260 monitors the sensor data from the sensors of the RCU 260 to determine one or more attributes of the RCU 260, including a position of the RCU 260 and a motion of the RCU 260. The position can indicate whether the RCU 260 is with the teacher or with one or more students. The motion of the RCU 260 can indicate an action being performed or a transition of the use mode. For example, a subtle up-and-down movement can indicate selection of a question, a subtle left-and-right movement can indicate selection of an answer, and a throwing or rolling movement can indicate a use mode transition. Other user interactions with the RCU 260 can include squeezing the RCU 260, speaking into the RCU 260, bouncing the RCU 260, holding the RCU 260 above the head, etc. The RCU 260 is programmed to automatically interpret the sensor signals to determine the use mode and cause actions to be performed on the IOD 210.

FIG. 7C illustrates an example of presenting a competitive game based on interaction with the remote-control unit in a physical room in accordance with an illustrative embodiment. In the depicted example, the RCU 260 has a ball form factor and communicates with dongle 211 to control content presented on IOD 210. The RCU 260 communicates with dongle 211 via wireless communication protocols, such as the Bluetooth® short-range wireless technology standard or the IEEE 802.11 family of standards, to control content on IOD 210. In this example, the content being presented on IOD 210 is a question answering game between two teams of students, Team A 740 and Team B 750.

In one embodiment, a set of questions is presented on the screen of IOD 210, and a current question is presented in the right panel of the screen of IOD 210 with a set of answers. When Team A 740 is in control of the RCU 260, it is in a Team A use mode and capable of performing a first set of student actions. For example, the first set of student actions can include selecting an answer to the question presented on a right panel of the screen of IOD 210. In one embodiment, the answer selection action can be mapped to a particular interaction with the RCU 260, such as moving the RCU 260 left-and-right in the air and squeezing the RCU 260 to select the answer.

In another embodiment, the IOD 210 can cycle between answers shown on the screen of IOD 210, and a user on Team A 740 can perform a user interaction with the RCU 260 signaling to stop on an answer. Thus, the competitive game requires the user to know the answer and to time the user interaction to select the correct answer. The user interaction can include squeezing, warming, hitting, rolling, rotating, bouncing the RCU 260, or otherwise changing the state of the RCU 260. After answering the question, the user on Team A 740 can then throw or roll the RCU 260 to Team B 750 to allow one of the students on Team B 750 to answer the next question.

When Team B 750 is in control of the RCU 260, it is in a Team B use mode and capable of performing a second set of student actions. For example, the second set of student actions can be the same as the first set of student actions for Team A 740, including selection of an answer to the question presented on a right panel of the screen of IOD 210. After answering the question, the user on Team B 750 can then throw or roll the RCU 260 to Team A 740 to allow one of the students on Team A 740 to answer the next question.

In some embodiments, Team A might be in front of the IOD 210 while Team B 750 might be in front of the IOD 220. The Team A use mode can then be associated with controlling the IOD 210 only, while the Team B use mode can then be associated with controlling the IOD 220 only. The two IODs may present synchronized contents, while the IOD that does not receive commands from the RCU 260 may reduce or suspend the performance of the associated output device. In other embodiments, the Team A use mode may be determined by identities of the users in Team A or the person holding the RCU 260 with known profiles, which can dictate the questions selected or the manner the questions are presented by an IOD. For example, the Team A use mode may be associated with an action of selecting a question that was not answered correctly before by Team A or have a high difficulty level because the average test score of Team A is above a certain threshold. It can also be associated with an action of reading a question in a higher volume because someone in Team A has a poor hearing.

In another embodiment, each team can have its own RCU 260, and transition between user modes can be triggered by Team A 740 or Team B 750 selecting an answer to a question. For example, when a user of Team A 740 answers the current question and squeezes or bounces its RCU 260, the RCU 260 is programmed to transition into an inactive mode in which one or more of the first set of student actions are disabled. In this case, the RCU 260 can be configured to communicate this transition of use modes to the dongle 211. Alternatively, the RCU 260 can be configured to communicate the transition of use modes directly to the RCU of Team B. In response to the receiving an indication that Team B 750 answered its question, from the RCU of Team B or the dongle 211, the RCU 260 of Team A 740 then transitions from the inactive mode to the Team A use mode.

In some embodiments, when multiple RCUs are present and active in the physical room, the sensor signals processed by an RCU could also indicate the activities of another RCU. The states of two RCUs could provide a more accurate indicator of the relationships between two groups of users or more advanced indicators of the activities in the physical room. In other embodiments, different RCUs may have default priorities, which could change depending on the current use mode of each RCU. Such priority information could be communicated between IODs and RCUs. When an IOD is connected with multiple RCUs, the IOD can prioritize the commands received from different RCUs, such as always accepting only commands from the RCU with the highest priority based on its use mode until that RCU communicates an end of commands or becomes unreachable.

The RCU 260 monitors the sensor data from the sensors of the RCU 260 to determine one or more attributes of the RCU 260, including a position of the RCU 260 and a motion of the RCU 260. The position can indicate whether the RCU 260 is with the Team A 740 or Team B 750. The motion of the RCU 260 can indicate an action being performed or a transition of the use mode. For example, a subtle left-and-right movement can indicate selection of an answer and a throwing or rolling movement can indicate a use mode transition. Other user interactions with the RCU 260 can include squeezing the RCU 260, speaking into the RCU 260, bouncing the RCU 260, holding the RCU 260 above the head, etc. The RCU 260 is programmed to automatically interpret the sensor signals to determine the use mode and cause actions to be performed on the IOD 210.

In some embodiments, the IOD can be programmed to receive use mode information from RCUs and interpret the commands or actions received from an RCU based on the use mode of the RCU. For example, if an RCU sends an indication of a teacher use mode and speech or text input, then the IOD can interpret the speech or text input as a question being asked to the class or a lesson being presented. In the above example, inputs received from a first RCU in a teacher use mode can be used to control the question being asked of Team A or Team B and inputs received from second RCU in a student use mode can be used to control answers to the questions. In one embodiment, the IOD has mapping data structures similar to those of the RCUs. That is, the IOD can map the use mode of an RCU to content presentation operations that can be performed by an application running on the IOD in that use mode and can map inputs received from the RCU to those operations. Thus, each RCU is configured to send an identifier of its use mode to the IOD, and the IOD is programmed to interpret subsequent (or concurrent) actions to the identified use mode.

### 6. Example Processes

Aspects of the illustrative embodiments are described herein with reference to flowchart illustrations. It will be understood that each block of the flowchart illustrations and combinations of blocks in the flowchart illustrations can be implemented by computer readable program instructions. These computer readable program instructions can be provided to a processor of a general-purpose computer, special purpose computer, or other programmable data processing apparatus to produce a machine, such that the instructions, which execute via the processor of the computer or other programmable data processing apparatus, implement the activities specified in the flowcharts.

The flowchart and block diagrams in the figures illustrate the architecture, functionality, and operation of possible implementations of systems, methods, and computer readable storage media according to various embodiments. In this regard, each block in the flowchart may represent a module, segment, or portion of instructions, which comprises one or more executable instructions for implementing the specified logical functions. In some alternative implementations, the functions noted in a block can occur out of the order noted in the figures. For example, two blocks shown in succession can, in fact, be executed substantially concurrently, or the blocks can sometimes be executed in the reverse order, depending upon the functionality involved.

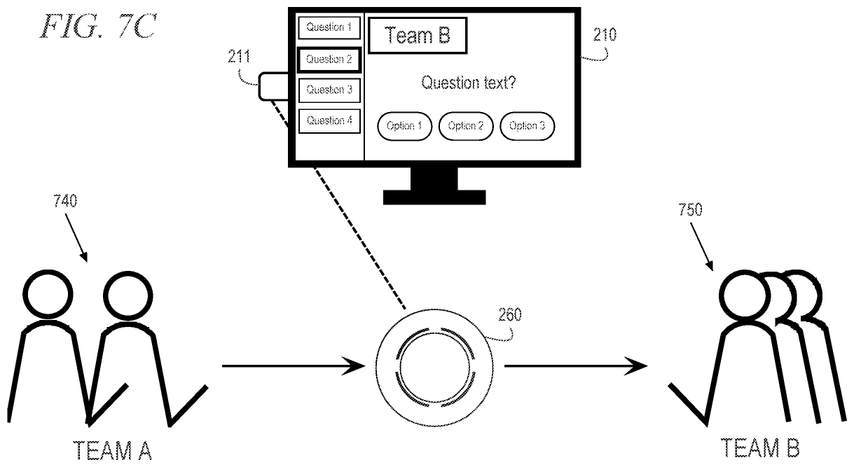

FIG. 8 is a flowchart illustrating operation of a remote-control unit for pairing with integrated output devices in accordance with an illustrative embodiment. Operation begins (block 800, and the user pushes a button on the remote-control unit (RCU) to put the RCU in pairing mode (block 801). The RCU is configured or programmed to search for compatible devices, such as integrated output devices (IODs) or dongles for controlling IODs, in the surrounding area (block 802). In one embodiment, the surrounding area is defined by a signal range of the wireless technology (e.g., the Bluetooth® short-range wireless technology standard) used for communicating between the RCU and the devices with which the RCU is being paired. The RCU is configured to determine whether a new device is detected (block 803). If a new device is not detected (block 803: NO), then operation returns to block 802 to search for compatible devices until a new device is detected.

If a new device is detected (block 803: YES), then the RCU is configured to pair with the device and prompt the user to name the device (block 804). In some embodiments, the device is a dongle for controlling an IOD. The user can name the device based on its association with the IOD. For example, if the dongle is coupled to a projector display device, then the user can name the dongle being paired as “Projector Display,” as shown in FIG. 4.

If more than one IOD is paired, via more than one dongle, then the RCU is configured to prompt the user to arrange IOD cards on the interface of the RCU so that the card setup is physically congruent (block 805). That is, a user can rearrange the IOD user interface cards such that a IOD user interface card on the left corresponds to an IOD on the left side of the content presentation environment, an IOD user interface card in the center corresponds to an IOD in the center of the content presentation environment, and an IOD user interface card on the right corresponds to an IOD on the right side of the content presentation environment.

The RCU is configured to query the device capabilities and present feedback to the user (block 806). The device capabilities can be collected by the dongle, such as by identifying applications installed on the IOD. The user can use the device capability feedback to select an IOD for presenting content. For instance, if the user wishes to present a video, then the user can switch to an IOD card that indicates an IOD with a capability of displaying videos. Thus, the user can switch from a smart speaker IOD card to a smart TV IOD card. Thereafter, operation ends (block 807).

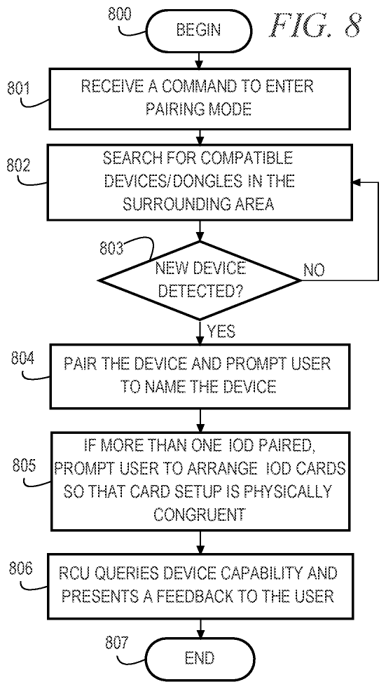

FIG. 9 is a flowchart illustrating operation of a remote-control unit for managing user control based on user role in accordance with an illustrative embodiment. Operation begins (block 900), and determination is made whether the RCU is paired to at least one IOD (block 901). If the RCU is not paired to at least one IOD (block 901: NO), then the RCU is configured to prompt the user to pair with an IOD (block 902), and operation returns to block 801 until the RCU is paired to at least one IOD.

If the RCU is paired to at least one IOD (block 901: YES), then a determination is made whether a user is logged in (block 903). If a user is not logged in (block 903: NO), then the RCU is configured to prompt the user to log in (block 904). A determination is made whether login of the user is successful (block 905). If login is not successful (block 905: NO), then the RCU is configured to allow limited control of both the RCU and the IOD to the user (block 906). Operation returns to block 902 to prompt the user to pair a device responsive to the user selecting a pair new device option in the RCU. Operation returns to block 904 to prompt the user to log in responsive to the user selecting a login option in the RCU.

If the user is logged in (block 903: YES) or login is successful (block 905: YES), then a determination is made whether the user is a teacher or administrator (block 907). If the user is not a teacher or administrator (block 907: NO), then operation returns to block 906 to allow limited control of both the RCU and the IOD. If the user is a teacher or administrator (block 907: YES), then the RCU is configured to automatically log in to services and customize the user interface (UI) on the IOD for the user (block 908). The RCU is configured to allow full control of both the RCU and the IOD to the user (block 909). A determination is made whether there is a period of inactivity or the session has ended or the user logged into the RCU has changed (block 910). If there is no inactivity/session end/user change detected (block 910: NO), then operation returns to block 909 to allow full control of the RCU and IOD.

If there is inactivity/session end/user change detected (block 910: YES), then the RCU is configured to notify the user to log out with an option to log back in (block 911). The RCU is configured to log the user out from the RCU and the services on the IOD (block 912). Then, operation returns to block 906 to allow limited control of the RCU and IOD.

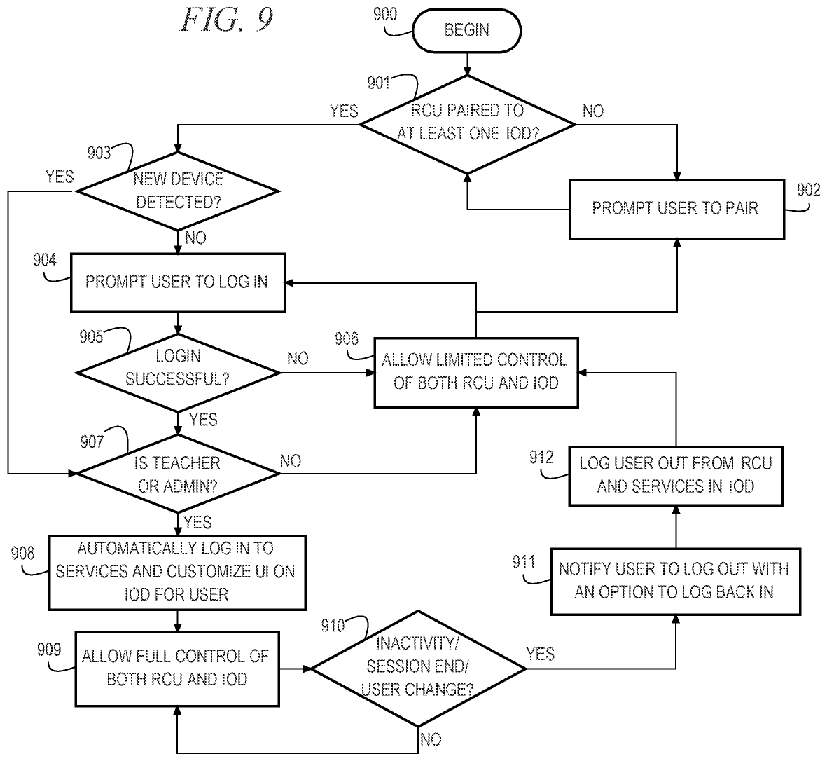

FIG. 10 is a flowchart illustrating operation of a smart remote-control unit that adapts to a physical environment based on attributes of the remote-control unit in accordance with an illustrative embodiment. Operation begins (block 1000), and a use mode determination service of the remote-control unit (RCU) receives sensor data from a plurality of RCU sensors (block 1001). The use mode determination service determines RCU attributes based on the sensor data (block 1002). The RCU attributes can include a user of the RCU, a position and orientation of the RCU, movement of the RCU, squeezing of the RCU, etc.

The use mode determination service determines a use mode based on the RCU attributes (block 1003). The use mode determination service determines whether there is a change of use mode (block 1004). If there is a change of use mode (block 1004: YES), then the use mode determination service communicates the transition of use mode to an IOD, if there is an IOD paired with the RCU that can intelligently interpret RCU commands and actions based on use mode (block 1005). In some embodiments, information regarding the use mode could be communicated to the IOD together at the same time with information regarding an action to be performed by the IOD. In other embodiments, information regarding the use mode is not communicated to the IOD, and only information regarding an action to be performed by the IOD is communicated to the IOD.

Thereafter, or if there is not a change of use mode (block 1004: NO), then the use mode determination service then determines whether user input is received indicating a user interaction with the RCU (block 1006). If no user input is received (block 1006: NO), then operation returns to block 1001 to receive data from the RCU sensors. If user input is received (block 1006: YES), then an input processing service of the RCU identifies one or more actions mapped to the user input based on a current use mode of the RCU (block 1007). The input processing service transmits RCU commands for the one or more actions mapped to the user input based on the use mode to the IOD (block 1008). Thereafter, the IOD interprets the RCU commands based on the use mode, and operation returns to block 1001 to receive data from the RCU sensors.

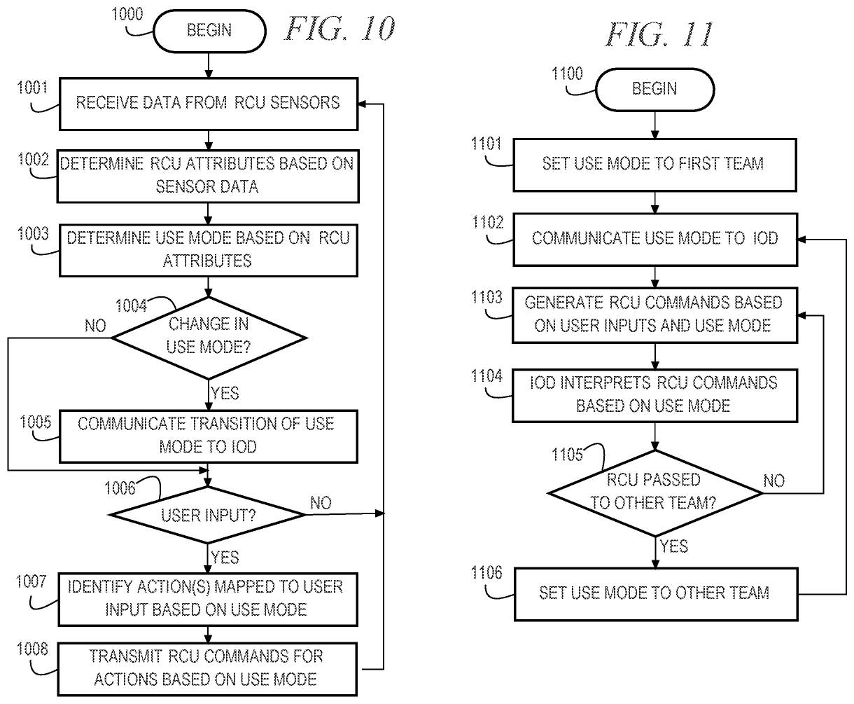

FIG. 11 is a flowchart illustrating operation of a smart remote-control unit for a competitive game between two teams in accordance with an illustrative embodiment. Operation begins (block 1100), and the RCU is configured to set the use mode to a first team (block 1101). The RCU communicates the use mode to an IOD, which presents a question or task to the first team (block 1102). The RCU is programmed to generate RCU commands based on user inputs and the use mode (block 1103). The IOD interprets the RCU commands based on the use mode (block 1104).

The RCU is programmed to determine whether the RCU is passed to another team (block 1105). If the RCU is not passed to another team (block 1105: NO), then operation returns to block 11093 to generate RCU commands based on user inputs and the use mode. If the RCU is passed to another team (block 1105: YES), then the RCU is configured to set the use mode to the other team (block 1106), and operation returns to block 1102 to communicate the use mode to the IOD.

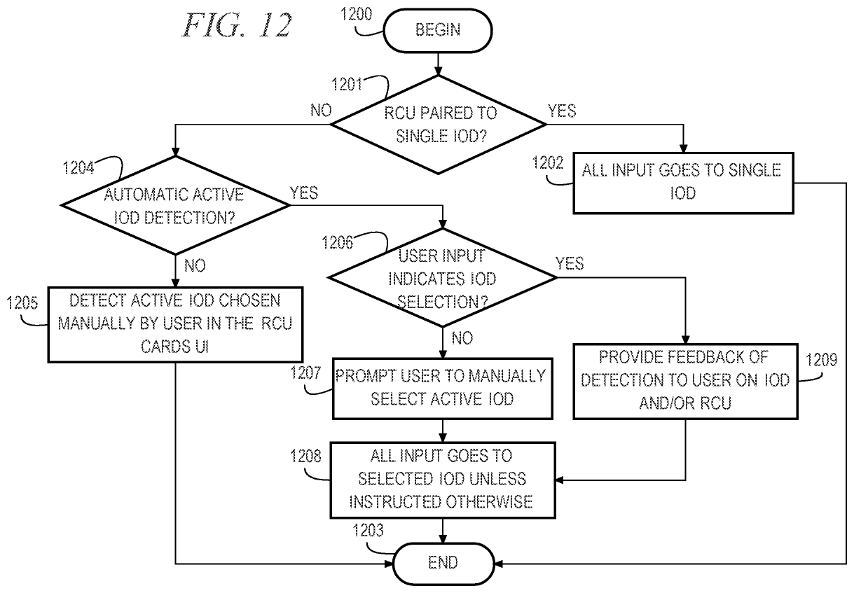

FIG. 12 is a flowchart illustrating operation of a smart remote-control unit for selecting an integrated output device for content presentation control in accordance with an illustrative embodiment. Operation begins (block 1200), and the RCU is programmed to determine whether the RCU is paired to a single IOD (block 1201). If the RCU is paired to a single IOD (block 1202: YES), then all input goes to the single IOD (block 1202), and operation ends (block 1203).

If the RCU is not paired to a single IOD (block 1202: NO), then the RCU is programmed to determine whether automatic active IOD detection is enabled (block 1204). In some embodiments, automatic active IOD detection can be implemented as use mode detection by a smart RCU. For example, the RCU can receive sensor data from sensors of the RCU and determine whether the RCU is being moved toward and/or pointed at an IOD, which can indicate that the user wishes to control the IOD. Controlling content presentation on a particular IOD can be a use mode of the RCU, as opposed to other use modes, such as a teacher conducting a test or quiz, a teacher presenting a lesson, or a student playing an educational game. If automatic active IOD detection is not enabled (block 1204: NO), then the RCU is programmed to detect an active IOD chosen manually by the user in the RCU cards user interface (block 1205), and operation ends (block 1203).

If automatic active IOD detection is enabled (block 1204: YES), then the RCU is programmed to determine whether user input indicates an IOD selection (block 1206). User input that can indicate an IOD selection can include moving the RCU within a predetermined distance of the IOD, thrusting the RCU at the IOD, or pointing the RCU at the IOD. If user input does not indicate an IOD selection (block 1206: NO), then the RCU is programmed to prompt the user to manually select an active IOD (block 1207). Then, all input goes to the selected IOD unless instructed otherwise (block 1208), and operation ends (block 1203).

If user input indicates IOD selection (block 1206: YES), then the RCU provides feedback of detection to the user on the IOD and/or the RCU (block 1209). The feedback of the detection can indicate detection of a particular use mode associated with controlling the selected IOD, for example. The feedback informs the user that subsequent user interaction with the RCU will be interpreted based on the use mode of controlling the selected IOD. Then, all input goes to the selected IOD unless instructed otherwise (block 1208), and operation ends (block 1203). A user can instruct the RCU to no longer send all input to the selected IOD by transitioning the RCU into another use mode, for example.

### 7. Hardware Implementation

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

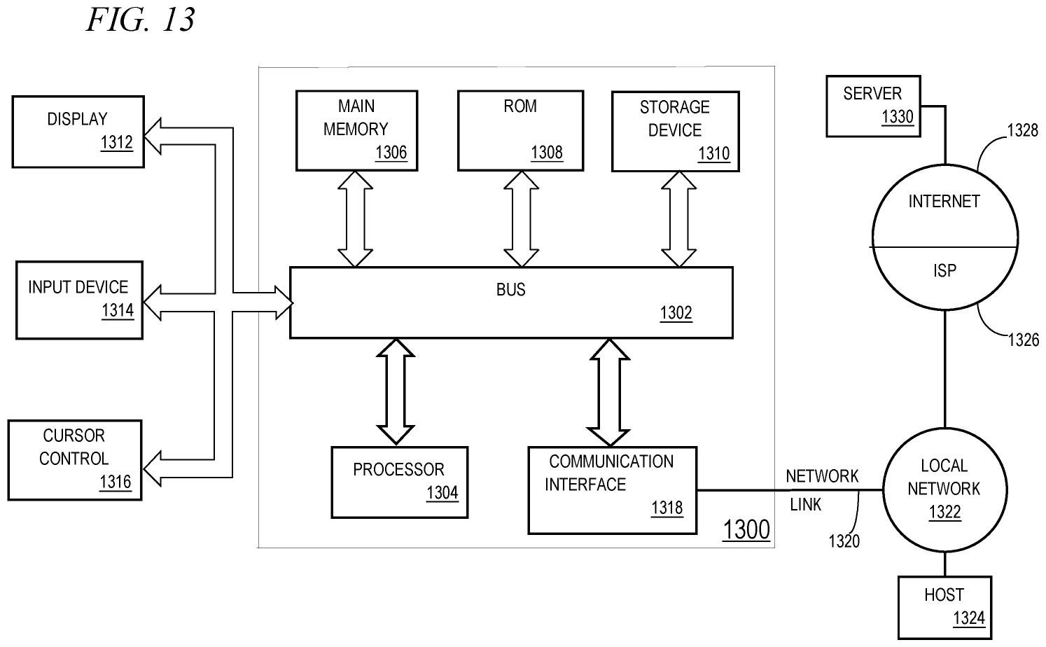

For example, FIG. 13 is a block diagram that illustrates a computer system 1300 upon which an embodiment of the invention may be implemented. Computer system 1300 includes a bus 1302 or other communication mechanism for communicating information, and a hardware processor 1304 coupled with bus 1302 for processing information. Hardware processor 1304 may be, for example, a general-purpose microprocessor.

Computer system 1300 also includes a main memory 1306, such as a random-access memory (RAM) or other dynamic storage device, coupled to bus 1302 for storing information and instructions to be executed by processor 1304. Main memory 1306 also may be used for storing temporary variables or other intermediate information during execution of instructions to be executed by processor 1304. Such instructions, when stored in non-transitory storage media accessible to processor 1304, render computer system 1300 into a special-purpose machine that is customized to perform the operations specified in the instructions.

Computer system 1300 further includes a read only memory (ROM) 1308 or other static storage device coupled to bus 1302 for storing static information and instructions for processor 1304. A storage device 1310, such as a magnetic disk, optical disk, or solid-state drive is provided and coupled to bus 1302 for storing information and instructions.

Computer system 1300 may be coupled via bus 1302 to a display 1312, such as a cathode ray tube (CRT), for displaying information to a computer user. An input device 1314, including alphanumeric and other keys, is coupled to bus 1302 for communicating information and command selections to processor 1304. Another type of user input device is cursor control 1316, such as a mouse, a trackball, or cursor direction keys for communicating direction information and command selections to processor 1304 and for controlling cursor movement on display 1312. This input device typically has two degrees of freedom in two axes, a first axis (e.g., x) and a second axis (e.g., y), that allows the device to specify positions in a plane.

Computer system 1300 may implement the techniques described herein using customized hard-wired logic, one or more ASICs or FPGAs, firmware and/or program logic which in combination with the computer system causes or programs computer system 1300 to be a special-purpose machine. According to one embodiment, the techniques herein are performed by computer system 1300 in response to processor 1304 executing one or more sequences of one or more instructions contained in main memory 1306. Such instructions may be read into main memory 1306 from another storage medium, such as storage device 1310. Execution of the sequences of instructions contained in main memory 1306 causes processor 1304 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 1310. Volatile media includes dynamic memory, such as main memory 1306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1302. Transmission media can also take the form of acoustic or light waves, such as those generated during radio-wave and infra-red data communications.

Various forms of media may be involved in carrying one or more sequences of one or more instructions to processor 1304 for execution. For example, the instructions may initially be carried on a magnetic disk or solid-state drive of a remote computer. The remote computer can load the instructions into its dynamic memory and send the instructions over a telephone line using a modem. A modem local to computer system 1300 can receive the data on the telephone line and use an infra-red transmitter to convert the data to an infra-red signal. An infra-red detector can receive the data carried in the infra-red signal and appropriate circuitry can place the data on bus 1302. Bus 1302 carries the data to main memory 1306, from which processor 1304 retrieves and executes the instructions. The instructions received by main memory 1306 may optionally be stored on storage device 1310 either before or after execution by processor 1304.

Computer system 1300 also includes a communication interface 1318 coupled to bus 1302. Communication interface 1318 provides a two-way data communication coupling to a network link 1320 that is connected to a local network 1322. For example, communication interface 1318 may be an integrated services digital network (ISDN) card, cable modem, satellite modem, or a modem to provide a data communication connection to a corresponding type of telephone line. As another example, communication interface 1318 may be a local area network (LAN) card to provide a data communication connection to a compatible LAN. Wireless links may also be implemented. In any such implementation, communication interface 1318 sends and receives electrical, electromagnetic or optical signals that carry digital data streams representing various types of information.

Network link 1320 typically provides data communication through one or more networks to other data devices. For example, network link 1320 may provide a connection through local network 1322 to a host computer 1324 or to data equipment operated by an Internet Service Provider (ISP) 1326. ISP 1326 in turn provides data communication services through the world wide packet data communication network now commonly referred to as the “Internet” 1328. Local network 1322 and Internet 1328 both use electrical, electromagnetic or optical signals that carry digital data streams. The signals through the various networks and the signals on network link 1320 and through communication interface 1318, which carry the digital data to and from computer system 1300, are example forms of transmission media.

Computer system 1300 can send messages and receive data, including program code, through the network(s), network link 1320 and communication interface 1318. In the Internet example, a server 1330 might transmit a requested code for an application program through Internet 1328, ISP 1326, local network 1322 and communication interface 1318.

The received code may be executed by processor 1304 as it is received, and/or stored in storage device 1310, or other non-volatile storage for later execution.

### 8. Extensions and Alternatives

In other embodiments, the RCU is programmed to use machine learning models to interpret sensor data. For example, a machine learning model can be trained based on a training data set including user inputs by known users. The machine learning model can be trained to distinguish between user interactions with the RCU by teachers versus user interactions with the RCU by students. Thus, the RCU can be programmed to identify the user of the RCU based on how the RCU is being used. Furthermore, machine learning models can be trained for particular user interactions. For instance, a machine learning model can be trained to detect a thrust versus a wave or a throw versus a roll based on a combination of sensor inputs, such as motion sensors, camera, microphone, and pressure sensors, for example.

In other embodiments, a machine learning model can be trained to learn and predict what action a user intends to perform based on the sensor data. Thus, a user can perform interactions with the RCU to cause particular operations to be performed. The machine learning model then learns which sets of sensor data correlate to which operations the user intends to perform. The machine learning model can be trained for individual users or groups of users. For example, a machine learning model can learn what user interactions teachers tend to perform to select an object on a screen and another machine learning model can learn what user interactions students tend to perform to select an object on a screen.

In some embodiments, the RCU is customizable such that a user can decide which actions can be performed in each use mode and which user interactions with the RCU are mapped to each action. For example, one user may prefer to squeeze the RCU to select an object on the screen, and another user may prefer to bounce the RCU to select an object on the screen.

In the foregoing specification, embodiments of the invention have been described with reference to numerous specific details that can vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer-implemented method of managing human-computer interaction using a remote-control unit, the method comprising:
receiving, by a processor of the remote-control unit, sensor data from a plurality of sensors within the remote-control unit, continuously and in real time;
determining, by the processor, one or more attributes of the remote-control unit based on the sensor data, the one or more attributes including at least a first user of the remote-control unit and a position and orientation of the remote-control unit in a physical room;
determining, by the processor, a first use mode of the remote-control unit based on the one or more attributes of the remote-control unit, wherein the first use mode is mapped to a first set of actions to be performed on a first set of input/output (I/O) devices and wherein each action in the first set of actions is mapped to one or more interactions with the remote-control unit;
detecting, in response to determining the first use mode, user interactions with the remote-control unit based on the sensor data; and
responsive to the processor detecting a user interaction that is mapped to a corresponding action in the first set of actions, causing the corresponding action to be performed on one or more I/O devices of the first set of I/O devices.

2. The method of claim 1, further comprising:
detecting, by the processor, that the remote-control unit has transitioned from the first use mode to a second use mode based on the sensor data, wherein the second use mode is mapped to a second set of actions to be performed on a second set of I/O devices; and
responsive to detecting that the remote-control unit has transitioned from the first use mode to a second use mode, the processor causing a transition action to be performed on one or more I/O devices of the first set of I/O devices or the second set of I/O devices based on the second use mode.

3. The method of claim 2, wherein:
the remote-control unit has a substantially spherical shape,
the plurality of sensors includes a plurality of motion sensors,
detecting that the remote-control unit has transitioned from the first use mode to the second use mode comprises detecting that the remote-control unit has been thrown or rolled from the first user of the remote-control unit to a second user.

4. The method of claim 3, wherein the transition action comprises sending a first command to an input device of the first set of I/O devices to capture activities of the second user or a second command to an output device of the first set of I/O devices to address a request to the second user.

5. The method of claim 2, wherein:
the plurality of sensors further includes a camera or a position sensor,
detecting that the remote-control unit has transitioned from the first use mode to the second use mode comprises detecting that the remote-control unit has moved from a first location to a second location within the physical room, and
the transition action comprises turning off or assigning a lower priority to a first I/O device of the first set of I/O devices that is within a first distance from the first location or turning on or assigning a higher priority to a second I/O device of the second set of devices that is within a distance from the second location.

6. The method of claim 1, wherein:
the remote-control unit has a substantially spherical shape,
the plurality of sensors includes a plurality of motion sensors, and
the detected user interaction comprises shaking, waving, thrusting, throwing, rolling, or bouncing the remote-control unit.

7. The method of claim 1, wherein:
the plurality of sensors includes a plurality of pressure sensors, and
the detected user interaction comprises squeezing the remote-control unit.

8. The method of claim 1, wherein:
the physical room is a classroom,
the one or more I/O devices include an integrated output device that includes a processor and an output mechanism, and
the corresponding action comprises controlling presentation of content on the integrated output device.

9. The method of claim 8, wherein the first user of the remote-control unit is a teacher and wherein the detected user interaction comprises one of the following:
the teacher holding the remote-control unit over the teacher's head in a front area of the classroom, wherein the corresponding action comprises lowering a volume of the integrated output device;
the teacher pointing the remote-control unit at a ceiling of the classroom, wherein the corresponding action comprises increasing a volume of the integrated output device;
the teacher holding the remote-control unit to the teacher's mouth, wherein the corresponding action comprises sending a speech command to the integrated output device;
the teacher pointing the remote-control unit at the integrated output device within a predetermined distance from the integrated output device, wherein the corresponding action comprises sending one or more subsequent actions to the integrated output device;
the teacher passing the remote-control unit to a student, wherein the corresponding action comprises notifying the integrated output device of a change in active user; or
the teacher placing the remote-control unit face-down on a surface, wherein the corresponding action comprises dimming lights and playing soothing music.

10. The method of claim 8, wherein the first user of the remote-control unit is a student and wherein the detected user interaction comprises one of the following:
the student holding the remote-control unit to the student's mouth, wherein the corresponding action comprises sending a speech input to the integrated output device to answer a question presented on the integrated output device;
the student holding the remote-control unit over the student's head in a student seating area of the classroom, wherein the corresponding action comprises sending a request to be an active user to the integrated output device; or
the student passing the remote-control unit to a second student, wherein the corresponding action comprises notifying the integrated output device of a change in active user.

11. The method of claim 8, wherein:
the remote-control unit has a substantially spherical shape;
the plurality of sensors includes a plurality of motion sensors, a plurality of pressure sensors, and a microphone;
the first user of the remote-control unit is a student; and
the detected user interaction comprises one of the following:
the student squeezing the remote-control unit, wherein the corresponding action comprises sending a speech input to the integrated output device to answer a question presented on the integrated output device;
the student bouncing the remote-control unit, wherein the corresponding action comprises starting or stopping cycling of content being presented on the integrated output device; or
the student throwing or rolls the remote-control unit to a second student, wherein the corresponding action comprises notifying the integrated output device of a change in active user.

12. The method of claim 1, wherein the plurality of sensors includes a camera and wherein determining the one or more attributes of the remote-control unit comprises performing facial recognition on the first user of the remote-control unit.

13. The method of claim 1, wherein the plurality of sensors includes a microphone and wherein determining the one or more attributes of the remote-control unit comprises performing voice recognition on the first user of the remote-control unit.

14. The method of claim 1, wherein:
the one or more I/O devices include an integrated output device that includes a processor and an output mechanism,
causing the corresponding action to be performed comprises sending an identification of the first use mode and an identification of the corresponding action to the integrated output device,
the integrated output device determines a content presentation operation that corresponds to the identification of the first use mode and an identification of the corresponding action, and
the integrated output device performs the content presentation operation.

15. The method of claim 1, wherein:
the one or more I/O devices include a plurality of integrated output devices,
each integrated output device within the plurality of integrated output devices includes a processor and an output mechanism,
each integrated output device within the plurality of integrated output devices is paired to the remote-control unit,
determining the first use mode of the remote-control unit comprises detecting user selection of a particular integrated output device from the plurality of integrated output devices, and
the first set of actions comprises one or more actions for controlling presentation of content on the particular integrated output device.

16. A remote-control unit, comprising:
a plurality of sensors;
a processor; and
a memory storing instructions which, when executed by the processor, cause performance of a method of managing human-computer interaction, the method comprising:
receiving sensor data from the plurality of sensors continuously and in real time;
determining one or more attributes of the remote-control unit based on the sensor data, the one or more attributes including at least a first user of the remote-control unit and a position and orientation of the remote-control unit in a physical room;
determining a first use mode of the remote-control unit based on the one or more attributes of the remote-control unit, wherein the first use mode is mapped to a first set of actions to be performed on a first set of input/output (I/O) devices and wherein each action in the first set of actions is mapped to one or more interactions with the remote-control unit;
detecting, in response to determining the first use mode, user interactions with the remote-control unit based on the sensor data; and
responsive to the processor detecting a user interaction that is mapped to a corresponding action in the first set of actions, causing the corresponding action to be performed on one or more I/O devices of the first set of I/O devices.

17. The remote-control unit of claim 16, wherein:
the remote-control unit has a substantially spherical shape,
the plurality of sensors includes a plurality of motion sensors, and
the detected user interaction comprises shaking, waving, thrusting, throwing, rolling, or bouncing the remote-control unit.

18. The remote-control unit of claim 16, wherein:
the plurality of sensors includes a plurality of pressure sensors, and
the detected user interaction comprises squeezing the remote-control unit.

19. The remote-control unit of claim 16, further comprising:
an interior housing;
a wireless transceiver; and
an outer material surrounding the interior housing,
wherein:
the remote-control unit has a substantially spherical shape,
the wireless transceiver, the processor, the memory, and one or more of the plurality of sensors are contained within the interior housing, and
causing the corresponding action to be performed on the one or more I/O devices comprises sending a request to the one or more I/O devices using the wireless transceiver.

20. One or more non-transitory storage media storing instructions which, when executed by one or more computing devices, cause performance of a method of managing human-computer interaction using a remote-control unit, the method comprising:
receiving, by a processor of the remote-control unit, sensor data from a plurality of sensors within the remote-control unit, continuously and in real time;
determining, by the processor, one or more attributes of the remote-control unit based on the sensor data, the one or more attributes including at least a first user of the remote-control unit and a position and orientation of the remote-control unit in a physical room;
determining, by the processor, a first use mode of the remote-control unit based on the one or more attributes of the remote-control unit, wherein the first use mode is mapped to a first set of actions to be performed on a first set of input/output (I/O) devices and wherein each action in the first set of actions is mapped to one or more interactions with the remote-control unit;
detecting, in response to determining the first use mode, user interactions with the remote-control unit based on the sensor data; and
responsive to the processor detecting a user interaction that is mapped to a corresponding action in the first set of actions, causing the corresponding action to be performed on one or more I/O devices of the first set of I/O devices.
